(19) United States
(12) Patent Application Publication
(10) Pub. No.: US 2025/0191449 A1
(43) Pub. Date: Jun. 12, 2025

(54) PRIZE ACQUISITION GAME DEVICE

(71) Applicant: SEGA CORPORATION, Tokyo (JP)

(72) Inventors: Mitsuharu Fukazawa, Tokyo (JP); Takaya Goshozono, Tokyo (JP)

(73) Assignee: SEGA CORPORATION, Tokyo (JP)

(21) Appl. No.: 19/059,658

(22) Filed: Feb. 21, 2025

Related U.S. Application Data
(63) Continuation of application No. PCT/JP2023/018347, filed on May 16, 2023.

(30) Foreign Application Priority Data
Aug. 22, 2022 (JP) 2022-132101

(51) Int. Cl. G07F 17/32

(52) U.S. Cl. CPC G07F 17/3297; G07F 17/3211; G07F 17/3227

(57) ABSTRACT

A prize acquisition game device includes: a game device main body that comprises: a first prize catcher that comprises a first arm extending in a vertical direction of the prize acquisition game device and with which a first player plays a first prize acquisition game, and a second prize catcher that is disposed alongside the first prize catcher, comprises a second arm extending in the vertical direction, and with which a second player plays a second prize acquisition game; a display device that is disposed on a front side of the game device main body and has a first display and a second display; a detector that detects a start request to start an administration mode; and a controller that controls the first display and/or the second display based on a game progress status of the first prize acquisition game and/or the second prize acquisition game in response to the detector detecting the start request.

### BACKGROUND

### Technical Field

The present invention relates to a prize acquisition game device.

### Description of Related Art

Gaming devices such as a crane game, in which the goal is to acquire prizes (such as stuffed toys) held inside a housing or items that can be exchanged for the prizes (hereinafter referred to as a “prize acquisition game device”), are fun to operate and stimulate the player's desire to take on a challenge by using popular characters as prizes, and these games are therefore often installed not only in amusement facilities such as game arcades, but also in ordinary stores, shopping malls, and so forth. Various prize acquisition game devices have been proposed and put to commercial use in the past (for example, see Patent Document 1).

### PATENT LITERATURE

Patent Literature 1: Japanese Patent No. 6307721

### Technological Problems to be Solved by the Invention

However, with the conventional prize acquisition game device disclosed in Patent Document 1, the administrator usually cannot switch the game mode to an administration mode for performing maintenance or the like while a player is playing a prize acquisition game. Accordingly, if a technical trouble arises in a prize acquisition game, the administrator would not be able to take appropriate action. Also, if the administrator forcibly switches to the administration mode, the prize acquisition game currently being played by the player may end up being interrupted. As a result, there is the risk that this will affect the administrator's satisfaction with the ease of management, and the players' satisfaction with the prize acquisition game.

### SUMMARY

One or more embodiments of the present invention provide a prize acquisition game device such that when an administrator switches to an administration mode, said switching is performed appropriately based on the progress status of the prize acquisition game, which increases the satisfaction of both the administrator and the player.

According to one or more embodiments, the prize acquisition game device comprises: a game device main body having a first prize catcher that comprises a first arm extending in a vertical direction of the prize acquisition game device and with which a first player plays a first prize acquisition game, and a second prize catcher that is disposed alongside the first prize catcher, comprises a second arm extending in the vertical direction of the prize acquisition game device, and with which a second player plays a second prize acquisition game; a display device that is disposed on a front side of the game device main body and has a first display for the first prize catcher and a second display for the second prize catcher; a detector that detects a start request to start an administration mode used by an administrator; and a controller that controls at least one of the first display and the second display based on at least one of a game progress status of the first prize acquisition game and a game progress status of the second prize acquisition game in response to the detector detecting the start request.

When this configuration is employed, when the administrator switches to the administration mode, said switching can be performed appropriately based on the progress status of the prize acquisition game, making it possible to provide a prize acquisition game device that increases the satisfaction of both the administrator and the player.

In the prize acquisition game device, the start request includes a first start request that the detector can detect from an approach of an information medium associated with the game device main body or an operation of a physical key, and in response to the detector detecting the first start request, the controller may perform a first control that includes determining whether the first prize acquisition game is in progress in the first prize catcher and whether the second prize acquisition game is in progress in the second prize catcher, and displaying a menu screen in at least one of the first display and the second display corresponding to at least one of the first prize catcher in which the first prize acquisition game is not in progress and the second prize catcher in which the second prize acquisition game is not in progress.

Employing this configuration allows the administrator to switch to the administration mode even while a player's prize acquisition game is in progress, without the unintended interruption of a prize acquisition game being played by the player.

The prize acquisition game device may further comprise a start operation device that starts the administration mode, wherein the start request includes a second start request that the detector can detect from an operation of the start operation device, and in response to the detector detecting the second start request, the controller performs a second control to display the menu screen in each of the first display and the second display.

Employing this configuration allows the display in each of the first and second displays to be switched to the menu screen simultaneously with a simple method.

In the prize acquisition game device, the controller may perform the second control corresponding to the second start request in response to the detector simultaneously detecting a first start request that the detector can detect from an approach of an information medium associated with the game device main body or an operation of a physical key and the second start request.

Employing this configuration allows the second control corresponding to the second start request to be performed preferentially when the first start request and the second start request are detected simultaneously.

In the prize acquisition game device, the first control further includes displaying an operation object for shifting to the menu screen in at least one of the first display corresponding to the first prize catcher in which the first prize acquisition game is in progress and the second display corresponding to the second prize catcher in which the second prize acquisition game is in progress, and in response to the operation object displayed in the first display being operated while the operation object is being displayed in the first display, the controller may display a menu screen in the first display and also display a game screen in the second display.

When this configuration is employed, when one display is operated, the other display is returned to the game screen, and a prize acquisition game can be played on the prize catcher corresponding to the other display.

In the prize acquisition game device, while the menu screen is being displayed in the first display, in response to one of the menu items on the menu screen displayed in the first display being selected, the controller may display the selected menu item in the first display and also display the game screen in the second display.

When this configuration is employed, when one display is operated, the other display is returned to the game screen, and a prize acquisition game can be played on the prize catcher corresponding to the other display.

In the prize acquisition game device, after displaying the selected menu item in the first display and displaying the game screen in the second display, the controller may determine whether an operation of the menu item displayed in the first display has finished and whether the second prize acquisition game is in progress in the second prize catcher corresponding to the second display, and upon determining that the operation in the first display has finished and that the second prize acquisition game is not in progress in the second prize catcher, the controller may display the game screen in the first display and display the menu screen in the second display.

Employing this configuration makes it easy for the administrator to carry out successive operations on the second prize catcher.

In the prize acquisition game device, the menu screen includes a menu item along with a linked settings object for simultaneously performing shared settings for the first prize catcher and the second prize catcher, and the controller may perform the shared settings in response to the linked settings object being turned on and the menu item displayed in either the first display or the second display being operated.

Employing this configuration allows shared settings for the first prize catcher and the second prize catcher to be performed with a simple method.

With one or more embodiments of the present invention, when the administrator switches to the administration mode, said switching can be performed appropriately based on the progress of the prize acquisition game, making it possible to provide a prize acquisition game device that increases the satisfaction of both the administrator and the player.

### BRIEF DESCRIPTION OF THE DRAWINGS

FIG. 1 is an oblique view illustrating the configuration of a prize acquisition game device according to one or more embodiments;

FIG. 2 is a cross-sectional view along the II-II line in FIG. 1;

FIG. 3 is a cross-sectional view along the III-III line in FIG. 1;

FIG. 4 is a detail view of part A in FIG. 3;

FIG. 5 is an oblique view of a modification example of the control panel of the prize acquisition game device according to one or more embodiments;

FIG. 6 is a side view of a modification example of the control panel of the prize acquisition game device according to one or more embodiments;

FIG. 7 is a diagram of the configuration of the display unit of the prize acquisition game device according to one or more embodiments;

FIG. 8 is a cross-sectional view along the VIII-VIII line in FIG. 7;

FIG. 9 is a diagram of the configuration of an administrator key detection unit of the prize acquisition game device according to one or more embodiments;

FIG. 10 is an oblique view illustrating a state in which the rotating part of the prize support unit of the prize acquisition game device according to one or more embodiments is housed;

FIG. 11 is an oblique view of the prize support unit of the prize acquisition game device according to one or more embodiments in a state in which the rotating part of the prize support unit is protruding;

FIG. 12 is an exploded oblique view of the configuration of the prize support unit of the prize acquisition game device according to one or more embodiments;

FIG. 13 is an oblique view of the configuration of the main body part of the prize support unit of the prize acquisition game device according to one or more embodiments;

FIG. 14 is a plan view of the configuration of the first support of the prize support unit of the prize acquisition game device according to one or more embodiments;

FIG. 15 is an oblique view of the configuration of the first support of the prize support unit of the prize acquisition game device according to one or more embodiments;

FIG. 16 is an oblique view of the configuration of the rotating part of the prize support unit of the prize acquisition game device according to one or more embodiments;

FIG. 17 is a detail view of part B in FIG. 10;

FIG. 18 is a diagram illustrating the linking of prize support units of the prize acquisition game device according to one or more embodiments;

FIG. 19 is an oblique view illustrating a prize acquisition unit and a drive unit as seen from above the prize acquisition game device according to one or more embodiments;

FIG. 20 is an oblique view illustrating the prize acquisition unit and the drive unit as seen from below the prize acquisition game device according to one or more embodiments;

FIG. 21 is a diagram illustrating the configuration of a part the prize acquisition unit of the prize acquisition game device according to one or more embodiments;

FIG. 22 is a diagram illustrating the configuration of the prize acquisition unit and a third drive unit of the prize acquisition game device according to one or more embodiments;

FIG. 23 is a diagram illustrating the configuration of the support of the third drive unit of the prize acquisition game device according to one or more embodiments;

FIG. 24 is a diagram illustrating the configuration of the main body part of the third drive unit of the prize acquisition game device according to one or more embodiments;

FIG. 25 is a diagram illustrating a state in which the main body part of the third drive unit approaches a prize when the biasing force applied by a biasing force adjustment part of the prize acquisition game device according to one or more embodiments is in a weak spring state;

FIG. 26 is a diagram illustrating a state in which the main body part of the third drive unit comes into contact with a prize when the biasing force applied by a biasing force adjustment part of the prize acquisition game device according to one or more embodiments is in a weak spring state;

FIG. 27 is a diagram illustrating a state in which the main body part of the third drive unit approaches a prize when the biasing force applied by a biasing force adjustment part of the prize acquisition game device according to one or more embodiments is in a strong spring state;

FIG. 28 is a diagram illustrating a state in which the main body part of the third drive unit comes into contact with a prize when the biasing force applied by a biasing force adjustment part of the prize acquisition game device according to one or more embodiments is in a strong spring state;

FIG. 29 is a diagram illustrating the display on the menu screen of the prize acquisition game device according to one or more embodiments;

FIG. 30 is a diagram illustrating the display of the first menu item of the prize acquisition game device according to one or more embodiments;

FIG. 31 is a diagram illustrating the display on the game screen of the prize acquisition game device according to one or more embodiments;

FIG. 32 is a diagram illustrating the movement range settings screen of the prize acquisition unit of the prize acquisition game device according to one or more embodiments;

FIG. 33 is a diagram illustrating the characteristics of operation buttons of the prize acquisition game device according to one or more embodiments;

FIG. 34 is a diagram illustrating a correspondence table relating to the correlation between an input by the user and the parameters of the prize acquisition unit of the prize acquisition game device according to one or more embodiments;

FIG. 35 is a diagram illustrating the functional configuration of a control unit of the prize acquisition game device according to one or more embodiments;

FIG. 36 is a flowchart illustrating the administration mode setting processing control performed by the control unit of the prize acquisition game device according to one or more embodiments;

FIG. 37 is a flowchart illustrating the detail of step S05 of FIG. 36;

FIG. 38 is a flowchart illustrating the detail of step S051 of FIG. 37;

FIG. 39 is a flowchart illustrating the detail of step S052 of FIG. 37;

FIG. 40 is a flowchart illustrating the detail of step S07 of FIG. 36;

FIG. 41 is a flowchart illustrating the detail of step S07 of FIG. 36;

FIG. 42 is a flowchart illustrating the main processing control of the prize acquisition game performed by the control unit of the prize acquisition game device according to one or more embodiments;

FIG. 43 is a flowchart illustrating the detail of step S10 of FIG. 42;

FIG. 44 is a flowchart illustrating the detail of step S20 of FIG. 42;

FIG. 45 is a flowchart illustrating the detail of step S30 of FIG. 42;

FIG. 46 is a flowchart illustrating the detail of step S50 of FIG. 42; and

FIG. 47 is a flowchart illustrating the detail of step S56 of FIG. 46.

### DETAILED DESCRIPTION

One or more embodiments will now be described with reference to the drawings. The positional relationships, such as the up, down, left, and right in the drawings, are based on the positional relationships shown in the drawings, unless otherwise specified. Also, the dimensional ratios in the drawings are not limited to those that are depicted. Furthermore, the following embodiments are given for the sake of describing the present invention, and is not intended to limit the present invention to each embodiment alone. Moreover, the present invention can be modified in various ways without departing from the gist thereof.

### Configuration of the Prize Acquisition Game Device 1

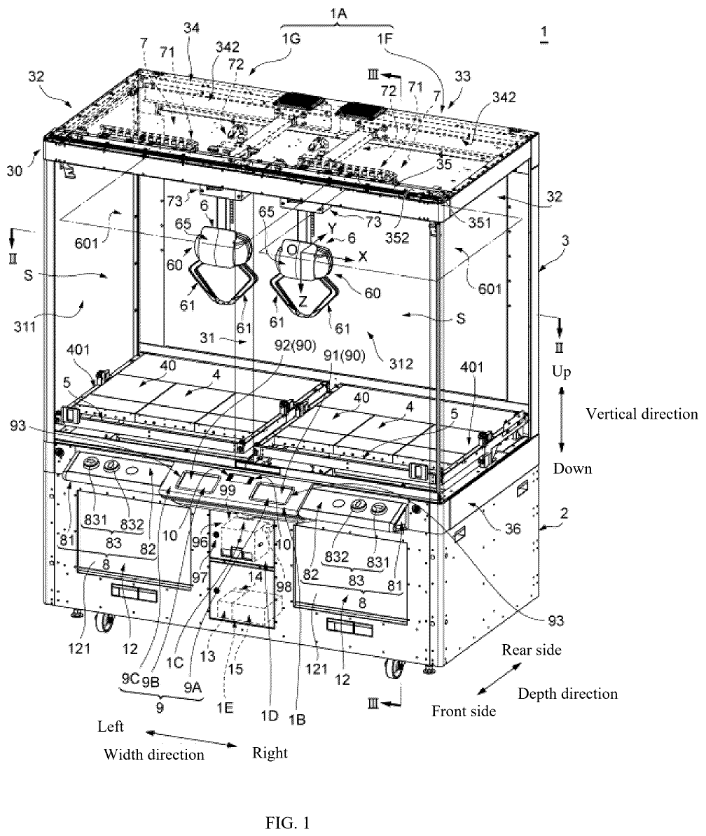

First, the configuration of the prize acquisition game device 1 according to one or more embodiments will be described with reference to FIGS. 1 to 34.

The prize acquisition game device 1 according to one or more embodiments is an example of a device for playing a prize acquisition game in which a prize is grasped and acquired. As shown in FIG. 1, the prize acquisition game device 1 comprises a game device main body 1A for playing a prize acquisition game; a display unit (or display device) 1B that is disposed on the front side of the game device main body 1A; a detection unit 1C that is disposed on the lower side of the display unit 1B and is able to detect an administrator key K; a service unit 1D that is provided in the game device main body 1A and used by the administrator to perform settings; and a control unit (or control device) 1E that is disposed inside the game device main body 1A and used to control various operations of the prize acquisition game device 1.

The width direction, depth direction, and vertical direction of the prize acquisition game device 1 and the game space S will sometimes be referred to as the “X direction,” the “Y direction,” and the “Z direction,” respectively. Also, unless specified otherwise, the “user” in the following description includes both the administrator who manages the prize acquisition game device 1 and the players who use the prize acquisition game device 1 to play a prize acquisition game.

### Game Device Main Body 1A

Next, the components of the game device main body 1A will be described in detail with reference to FIGS. 1 to 34.

The game device main body 1A is an example of the main body of a two-player game device in which two players can each play a prize acquisition game. As shown in FIG. 1, the game device main body 1A has a first prize catcher 1F that comprises a first arm (e.g., a pair of arms 61) extending in a vertical direction of the prize acquisition game device 1 with which a first player can play a first prize acquisition game, and a second prize catcher 1G that comprises a second arm (e.g., another pair of arms 61) extending in the vertical direction and with which a second player can play a second prize acquisition game. The first prize catcher 1F and the second prize catcher 1G are disposed side by side on the left and right in the width direction of the game device main body 1A. The first prize catcher 1F and the second prize catcher 1G both have the same configuration. Unless specified otherwise, the following description will focus on the first prize catcher 1F disposed on the right side.

In the example shown in FIG. 1, the first prize catcher 1F and the second crane claw device are described as being disposed side by side, but this is not the only option. The first prize catcher 1F and the second prize catcher 1G may instead be disposed back-to-back in the depth direction. Also, when the first prize catcher 1F and the second prize catcher 1G are small crane claw devices, they may be arranged vertically.

As shown in FIG. 1, the first prize catcher 1F comprises a main body part 2 that is provided at the bottom part of the first prize catcher 1F, a prize display unit (or prize display casing) 3 that is provided above the main body part 2 and has a game space S, a prize support plate 4 that supports prizes in the game space S, a prize drop opening 5 that is provided so as to couple the main body part 2 and the prize display unit 3 and that allows the prizes to fall, a prize acquisition unit 6 that is provided movably in the game space S and is used to acquire prizes, and a drive unit 7 that is provided above the game space S and drives the prize acquisition unit 6.

Here, the game space S is a space in which prizes are displayed and the prize acquisition unit 6 performs the operation of acquiring a prize. The prize may be any object that can be grasped by the prize acquisition unit 6, for example a toy such as a stuffed animal or a doll (including a toy in a box). Also, prizes are displayed in the prize display unit 3 upon being placed on the prize support plate 4.

Also, one or more multipurpose switches (not shown) are provided in the game space S. Here, the functions of each multipurpose switch are not fixed, and can be set by an administrator using a display unit 1B (discussed below). The setting of the functions of each multipurpose switch by the administrator using the display unit 1B will sometimes be referred to as the “function allocation setting of the multipurpose switch.” The purposes and function allocation setting of the multipurpose switch will be described in further detail below.

### Main Body Part 2

Next, the main body part 2 will be described in detail with reference to FIGS. 1 to 9.

As shown in FIG. 1, the main body part 2 has an operation unit (or operation device) 8 that is disposed on the front side, a coin insertion slot 10 for accepting game fees, a prize accommodating unit (or prize accommodating case) 11 that communicates with a prize drop opening 5, and a prize payout opening 12, which is an opening to the outside of the prize accommodating unit 11.

### Operation Unit 8

The operation unit 8 is used to perform various operations related to the prize acquisition game. The operation unit 8 has a housing 81, a control panel 82 that is disposed on the top surface of the housing 81, an operation part 83 that is disposed to the control panel 82 and is operated by the user, and a speaker (not shown) that is disposed on the lower side of the housing 81.

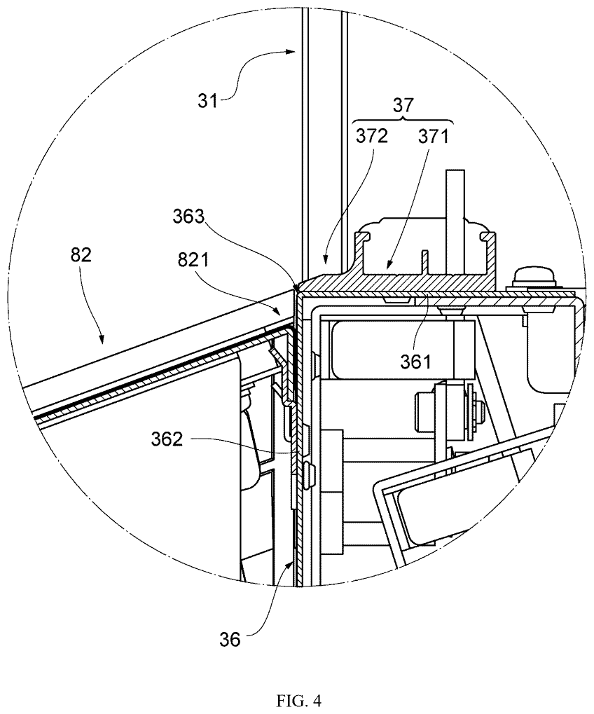

As shown in FIG. 4, the control panel 82 is disposed on the front side of a mounting unit (or placement part) 36 so as to cover an edge 363 of the mounting unit 36 of the prize display unit 3 (discussed below). The layout of the control panel 82 will be described in detail below along with a description of the mounting unit 36 of the prize display unit 3.

The operation part 83 is configured for operating the prize acquisition unit 6. More specifically, the operation part 83 is configured to receive a movement request corresponding to an operation of the prize acquisition unit 6 according to a user operation. Here, the movement request is a request made by the user to move the prize acquisition unit 6 in the X direction and/or the Y direction in a specific plane 601 within the game space S.

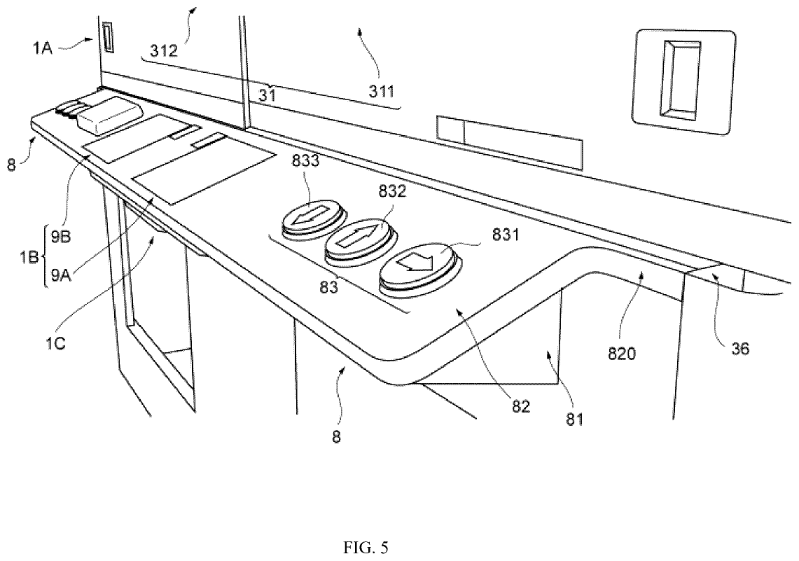

Also, the operation part 83 has a first button 831 for receiving a request to move the prize acquisition unit 6 in the X direction, and a second button 832 for receiving a request to move the prize acquisition unit 6 in the Y direction. The operation part 83 may be configured as something other than a button. For example, the operation part 83 may be a joystick, a lever, or the like. Also, in addition to the first button 831 and the second button 832, the operation part 83 may have a third button (see the third button 833 in the example shown in FIG. 5) for receiving a request to move the prize acquisition unit 6 in the Z direction.

The speaker is configured to output game sounds such as background music, alarm sounds, and so on. In a normal state, the speaker outputs game sounds such as background music. Meanwhile, the speaker can output an alarm sound in the event that the prize acquisition game device 1 is subjected to a certain impact.

### Coin Insertion Slot 10

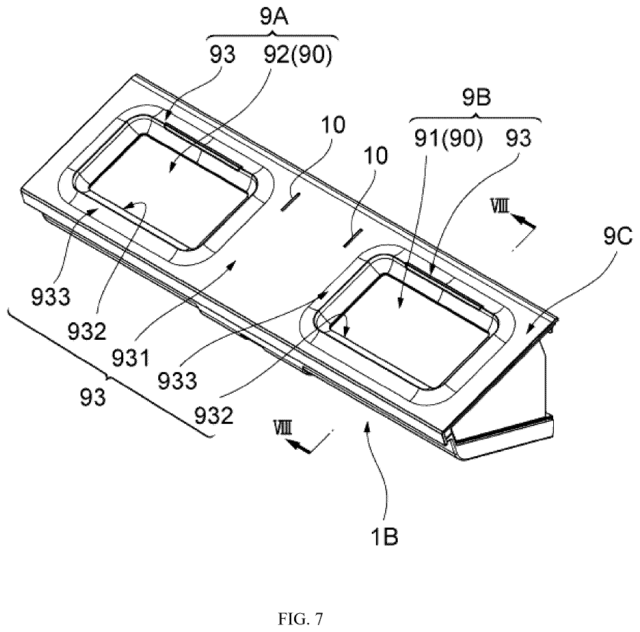

The coin insertion slot 10 is a used to accept coins from a user. As shown in FIGS. 1 and 7, the coin insertion slot 10 is formed so as to pass through a display panel 9C of the display unit 1B (discussed below). The coin insertion slot 10 may be formed so as to pass through the control panel 82 instead of the display panel 9C. The coin insertion slot 10 may have a length and width sufficient to allow a 500-yen coin, for example, to pass through.

Also, the coin insertion slot 10 may have a coin limiting unit or coin limiting tool (not shown) that is disposed on the back surface-side of the display panel 9C and that can be attached to the display panel 9C. The coin limiting unit is provided at one end of the coin insertion slot 10 in the lengthwise direction so as to straddle the width of the coin insertion slot 10 in order to shorten the lengthwise dimension of the coin insertion slot 10.

The coin limiting unit such as this can prevent coins of a certain size (such as 500-yen coins) from passing through the coin insertion slot 10, using a simple configuration. Also, since the coin limiting unit is provided on the back surface of the display panel 9C, attaching the coin limiting unit won't affect the appearance of the coin insertion slot 10. Furthermore, since the coin limiting unit can be easily attached and removed, attaching the coin limiting unit at a different position can also limit the passage of coins of different sizes from that of a 500-yen coin (such as foreign coins larger than a 500-yen coin), and the restriction on the coins that can be inserted can be easily eliminated by removing the coin limiting unit.

### Prize Accommodating Unit 11

The prize accommodating unit 11 is configured to temporarily accommodate a dropped prize before the user removes from the prize acquisition game device 1 a prize that has dropped out of the prize drop opening 5. The prize accommodating unit 11 is provided below the prize drop opening 5.

### Prize Payout Opening 12

The prize payout opening 12 is provided on the front side of the main body part 2 so as to permit access to the prize accommodating unit 11. A door 121 that can be opened and closed is attached to the prize payout opening 12. When the door 121 closes, the prize payout opening 12 is closed to prevent prizes from coming out, and to prevent entry of foreign objects, etc. (including for the theft of prizes) into the prize acquisition game device 1 through the prize payout opening 12. On the other hand, when the door 121 opens, the prize payout opening 12 is opened, and the prizes stored in the prize accommodating unit 11 can be taken out.

### Prize Display Unit 3

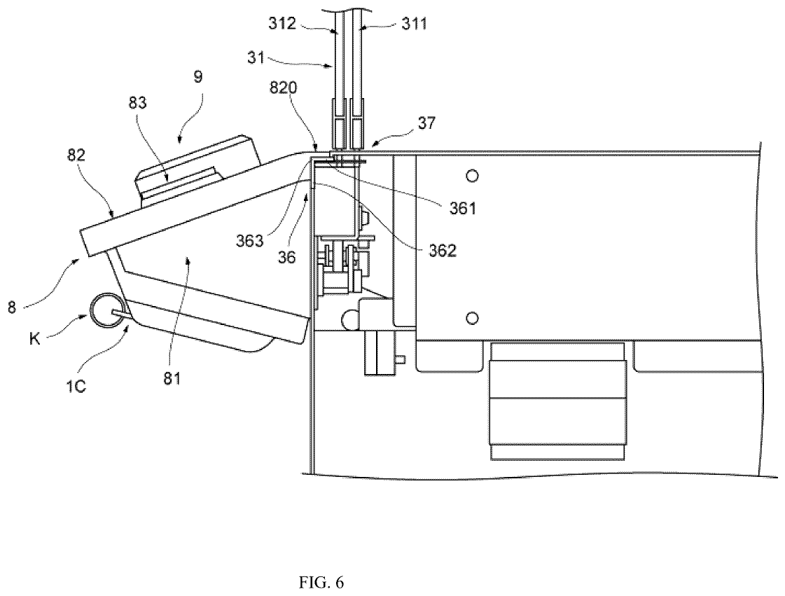

Next, the prize display unit 3 will be described in detail with reference to FIGS. 1 to 6. FIGS. 5 and 6 are diagrams illustrating modification examples of the cover portion of the mounting unit 36.

As shown in FIGS. 1 to 3, the prize display unit 3 has a housing part 30; a front panel 31, side panels 32, and a back panel 33 respectively provided to the front, both sides, and the back of the housing part 30; a support 34 that supports the drive unit 7 formed on the upper side of the housing part 30; an illumination unit (or illuminator) 35 provided on the front side above the support 34; and a mounting unit 36 formed on the lower side of the housing part 30 and on which the front panel 31 is mounted.

### Front Panel 31, Side Panels 32, and Back Panel 33

The front panel 31, the side panels 32, and the back panel 33 are configured to define the game space S. Also, the front panel 31, the side panels 32, and the back panel 33 are formed from a material through which light can pass, such as transparent acrylic resin or glass. This configuration affords a game space S that can be viewed from the front, both sides, and the back of the prize acquisition game device 1. The back panel 33 may be formed by a plate member of metal or the like.

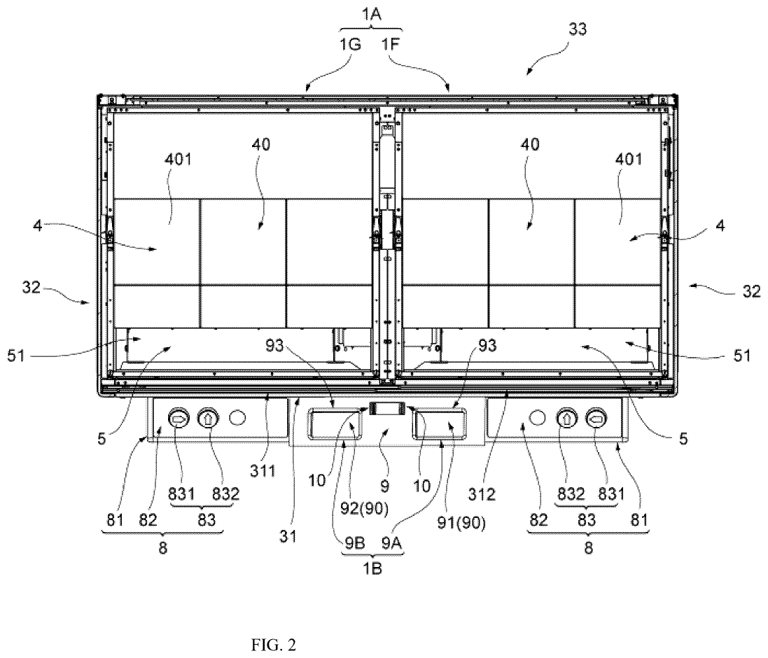

As shown in FIGS. 1 and 2, the front panel 31 has a first front panel 311 and a second front panel 312 that are able to slide in the width direction. The first front panel 311 is provided closer to the back side than the second front panel 312. The first front panel 311 and the second front panel 312 are an example of a door that allows the game space S to be opened and closed by sliding in the width direction. With this configuration, the administrator of the prize acquisition game device 1 can open the game space S by opening the first front panel 311 and the second front panel 312 in order to operate or perform maintenance on the prize acquisition unit 6, add more prizes, or perform other such jobs. Also, the administrator can operate the multipurpose switches provided in the opened game space S to execute the functions assigned to the operations of the multipurpose switches. The first front panel 311 and the second front panel 312 are closed to close off the game space S except when the administrator is servicing the device.

### Mounting Unit 36

The mounting unit 36 is configured to movably support the first front panel 311 and the second front panel 312. The surface of the mounting unit 36 is painted, as are the other portions of the housing part 30. Painting improves the aesthetic appearance of the visible portions of the mounting unit 36.

As shown in FIG. 4, the mounting unit 36 has a top surface part 361, a front surface part 362, an edge 363 formed by the top surface part 361 and the front surface part 362, and a sash 37 that is formed on the top surface part 361 and slidably supports the first front panel 311 and the second front panel 312 from below. Here, the sash 37 is an example of a support that supports the first front panel 311 and the second front panel 312 from below so that these can be opened and closed. The support may be configured as something other than a sash, such as a configuration in which the first front panel 311 and the second front panel 312 are each rotated open and closed.

The sash 37 is attached to the top surface part 361. As shown in FIG. 4, the sash 37 has a first portion 371 that is provided to the rear of the edge 363 of the top surface part 361 and supports the first front panel 311 and the second front panel 312, and a second portion 372 that is provided in front of the first portion 371 and covers the top surface-side portion of the edge 363. Thus, the second portion 372 of the sash 37 can function as part of the cover portion that covers the top surface portion of the edge 363 of the mounting unit 36. Although the sash 37 has been described as being formed separately from the top surface part 361, the sash 37 may instead be formed integrally with the top surface part 361.

Next, the positional relationship between the control panel 82 of the operation unit 8 and the mounting unit 36 will be described. The control panel 82 is disposed so as to be inclined with respect to the front surface part 362 of the mounting unit 36. To explain this in further detail, as shown in FIG. 4, the control panel 82 is disposed on the front surface part 362 of the mounting unit 36 so that the upper end part 821 located near the front surface part 362 will be positioned at the same level as or higher than the top surface part 361 of the mounting unit 36 so that the upper end of the front surface part 362 is hidden. In other words, the upper end part 821 is disposed so as to cover the front surface-side portion of the edge 363. Thus, the upper end part 821 of the control panel 82 can function as another part of the cover portion that covers the front surface part of the edge 363 of the mounting unit 36.

Therefore, the second portion 372 of the sash 37 and the upper end part 821 of the control panel 82 form a cover portion that covers the edge 363 of the mounting unit 36 so as to protect the edge 363. This cover portion prevents the edge 363 from being exposed to the outside. Therefore, given that the cover portion prevents the user's hand or belongings from touching the edge 363, the paint can be prevented from peeling off the edges 363 due to scratches or the like that would otherwise be caused when the user opens and closes the first front panel 311 and the second front panel 312. By preventing the paint from peeling off in this way, the aesthetic appearance of the mounting unit 36 can be improved and the durability of the mounting unit 36 increased. In addition, if the arrangement of the mounting unit 36 is different from the example shown in FIG. 4 (such as an arrangement in which the edges 363 are not exposed to the outside), or if the mounting unit 36 is not painted, a cover portion does not need to be provided to the edges 363.

Also, the layout of the control panel 82 is not limited to what was described above. For instance, the control panel 82 may be disposed so that the upper end part 821 thereof is in the same plane as the top surface part 361 of the mounting unit 36. Also, the control panel 82 may have a cover portion 820 that is configured integrally with the control panel 82, as shown in FIGS. 5 and 6. The cover portion 820 is an extension that is provided so as to extend from the upper end part 821 of the control panel 82. Also, as shown in FIGS. 5 and 6, the cover portion 820 is provided so as to cover the front surface-side portion and top surface-side portion of the edge 363. Also, the cover portion 820 may be configured separately from the control panel 82 and the sash 37. Also, the three portions consisting of the cover portion 820, the control panel 82, and the sash 37 may be configured integrally.

### Support 34

The support 34 is configured to movably support the drive unit 7 and to hold a portion of the drive unit 7 (a first drive unit 71 and a second drive unit 72; described below). As shown in FIG. 1, the support 34 has a rail 341 that is disposed on its inner peripheral surface and that movably supports the drive unit 7. The attachment of the support 34 and the drive unit 7 will be explained in detail in conjunction with a description of the drive unit 7.

### Illumination Unit 35

The illumination unit 35 is configured to emit light to the outside of the prize display unit 3. As shown in FIG. 1, the illumination unit 35 has a light guide member 351 and a plurality of light-emitting diodes 352 serving as light-emitting elements. The light guide member 351 is a transparent flat plate made of acrylic resin, and has a front emission surface and side emission surfaces. The plurality of light-emitting diodes 352 are provided on the back side of the light guide member 351.

Also, the light emitted by the plurality of light-emitting diodes 352 enters the end on the back side of the light guide member 351, is reflected inside the light guide member 351 and guided to the front side, and exits from the front emission surface and the side emission surfaces. In the normal state, the illumination unit 35 is lit. This improves the aesthetic appearance of the prize acquisition game device 1. On the other hand, in the event that the prize acquisition game device 1 is subjected to a certain impact, the illumination unit 35 flashes. Therefore, the illumination unit 35 can issue an alarm signal to the surroundings.

### Prize Support Plate 4

Next, the prize support plate 4 will be described in detail with reference to FIGS. 1 to 3 and FIGS. 10 to 18.

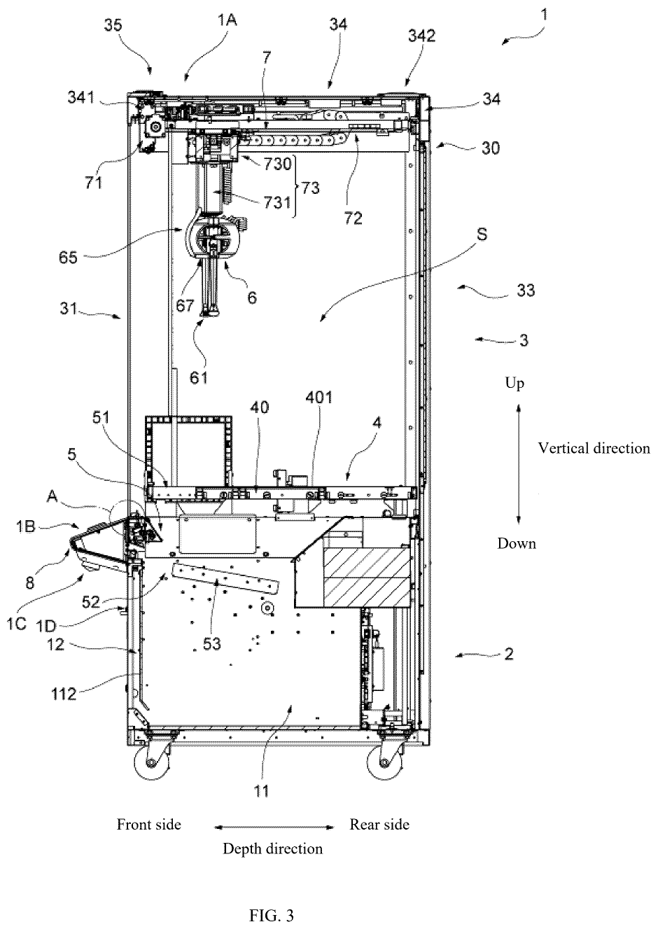

The prize support plate 4 has a flat structure formed between the main body part 2 and the prize display unit 3 in the vertical direction. As shown in FIGS. 1 and 3, the prize support plate 4 defines the game space S along with the front panel 31, the side panels 32, the back panel 33, and the support 34. The prize support plate 4 has a prize support surface 401 on the upper side in the thickness direction, on which prizes are placed.

As shown in FIGS. 1 and 2, the prize support plate 4 has a plurality of prize support units 40. The prize support units 40 are, for example, plate members made of a synthetic resin. A plurality of the prize support units 40 are connected to each other to form the prize support plate 4. Also, the plurality of prize support units 40 can be freely combined to form prize support plates 4 having different shapes. Consequently, the shape and size of the prize support surface 401 of the prize support plate 4 can be easily adjusted in response to changes in the type of prize or the game rules.

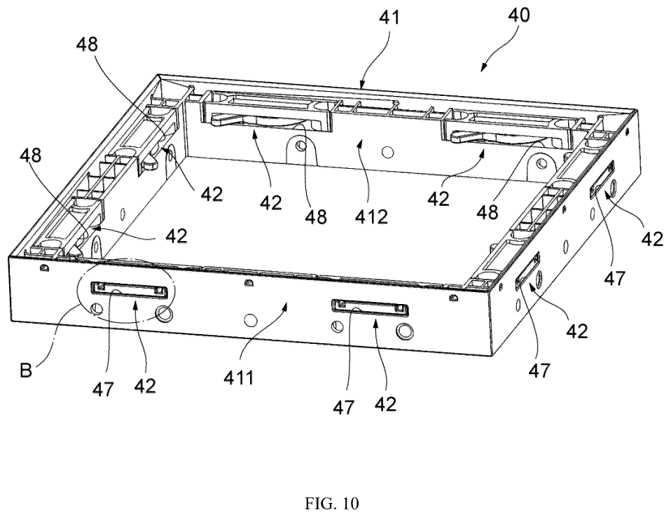

As shown in FIGS. 10 to 14, each prize support unit 40 has a main body part 41 that directly or indirectly supports a prize, and a plurality of linking parts 42 that are provided around the periphery of the main body part 41 and that link to other the prize support units 40.

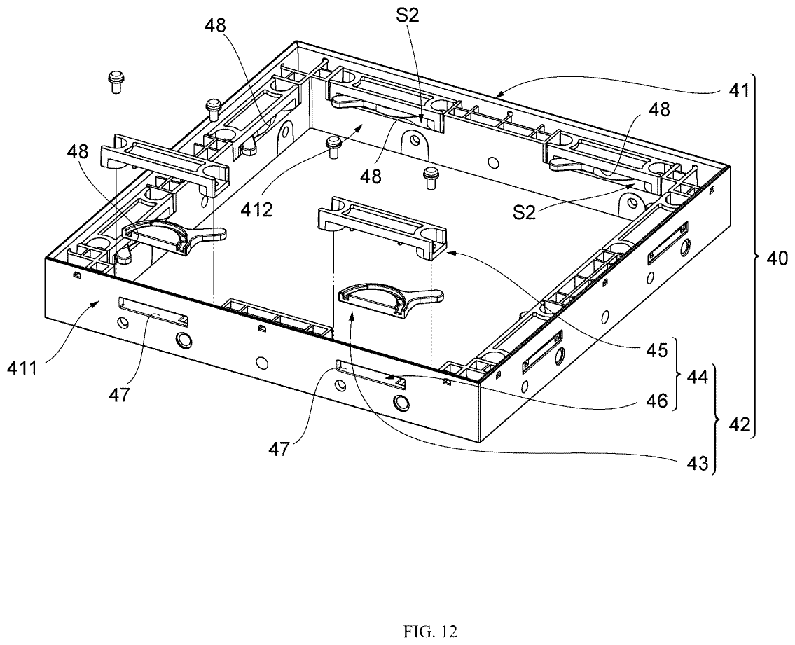

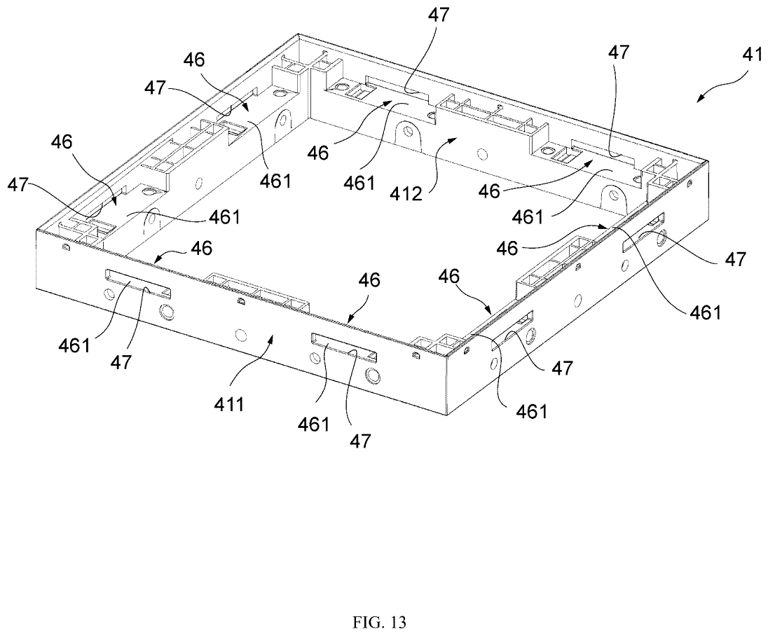

As shown in FIGS. 12 and 13, the main body part 41 is a frame-shaped member which has an outer peripheral surface 411 and an inner peripheral surface 412 as side surfaces. Also, a plate member is provided on the top surface of the main body part 41 for placing prizes (not shown).

As shown in FIG. 12, the linking parts 42 each have a rotating part (or rotator) 43 that is provided to be able to rotate relative to the main body part 41, and a support 44 that guides the rotation of the rotating part 43 while supporting the rotating part 43 by sandwiching it from both sides in the thickness direction of the rotating part 43. In the following description, a state in which the rotating part 43 is rotatably attached to the main body part 41 by the support 44 will sometimes be referred to as the “assembled state.”

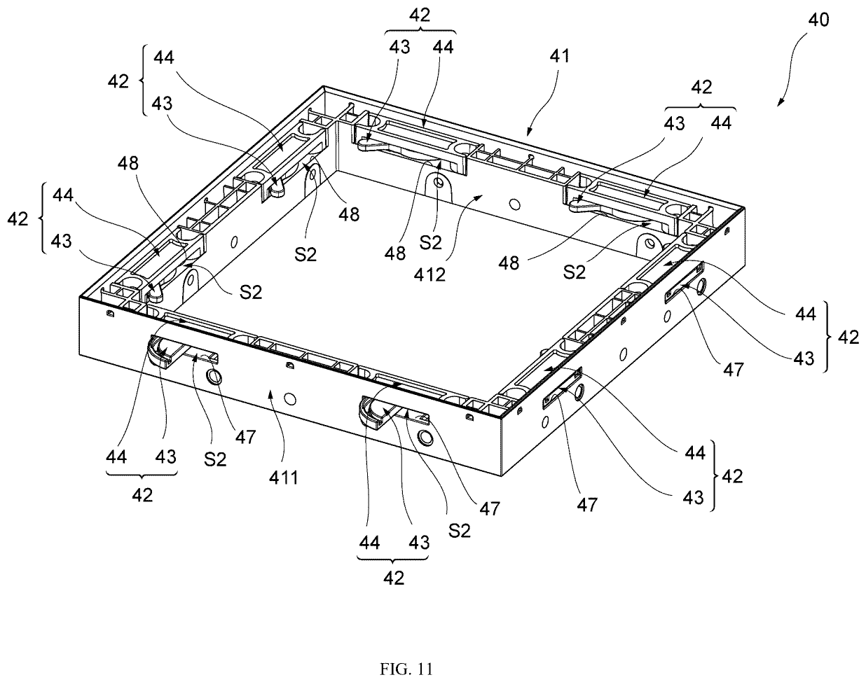

As shown in FIG. 12, the support 44 has a first support 45 that can be attached to the main body part 41, and a second support 46 that is a part of the main body part 41. As shown in FIGS. 11 and 12, a holding space S2 is formed between the first support 45 and the second support 46. As shown in FIGS. 10 to 12, the holding space S2 includes an opening 47 that opens to the outer peripheral surface 411 of the main body part 41, and a second opening 48 that opens to the inner peripheral surface 412 of the main body part 41 and is provided on the opposite side from the opening 47. As shown in FIGS. 10 and 11, the rotating part 43 is disposed in the holding space S2 so that it can, by rotating, enter and exit the holding space S2 through the opening 47.

In the above description, the main body part 41 was described as a single component, but may instead be configured to be divided into two sections, upper and lower, with the opening 47 as the boundary. In this case, either the upper or lower section of the main body part 41 may include the support 44. In other words, the support 44 corresponds to either of the upper and lower sections of the main body part 41. Also, the prize support unit 40 may be formed by sandwiching the rotating part 43 in between the upper and lower sections of the divided main body part 41.

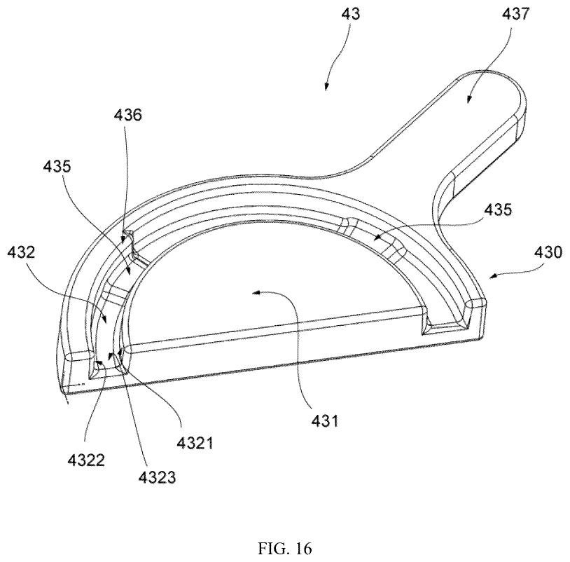

The configurations of the rotating part 43 and the first support 45 will now be described in greater detail. As shown in FIG. 16, the rotating part 43 has a main body part 430 and a knob 437 used for rotating the main body part 430. The main body part 430 is a plate member having a substantially semicircular shape in plan view. The main body part 430 has a first surface 431 on one side in its thickness direction, and a first part 432, which is a recessed part provided in the first surface 431. The rotating part 43 is provided such that the first surface 431 intersects the outer peripheral surface 411 so that it can, by rotating, enter and exit the holding space S2 through the opening 47.

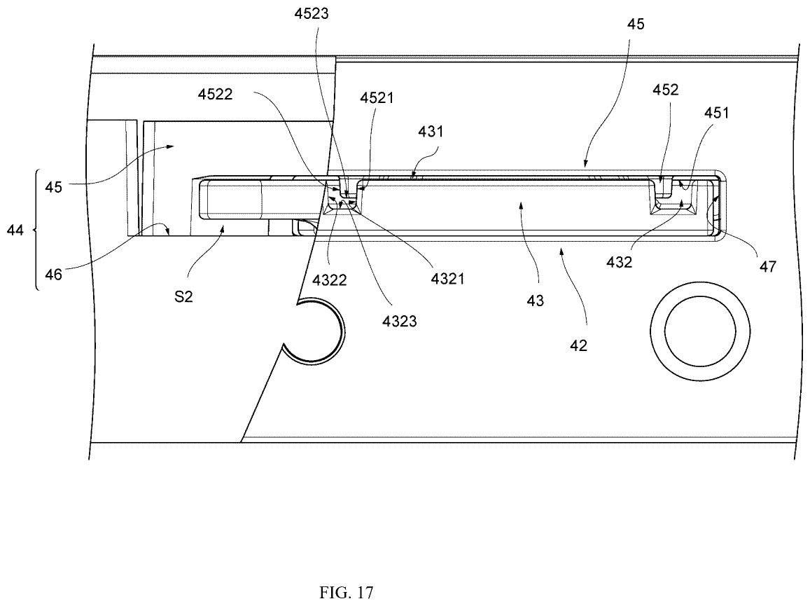

The first part 432 is a groove having a substantially semicircular ring shape in plan view. As shown in FIGS. 16 and 17, the first part 432 has a first side surface 4321, a third side surface 4322 opposing the first side surface 4321, and a bottom surface 4323 linking the first side surface 4321 and the third side surface 4322. As shown in FIG. 17, the first side surface 4321 is a portion that comes into contact with the first support 45. The first side surface 4321 is arc-shaped in plan view.

As shown in FIG. 16, the bottom surface 4323 of the first part 432 is provided with two first bottom surface stoppers 435 that are raised parts, and the third side surface 4322 is provided with a first side surface stopper 436 that is also a raised part. The first bottom surface stopper 435 and the first side surface stopper 436 are examples of a first stopper.

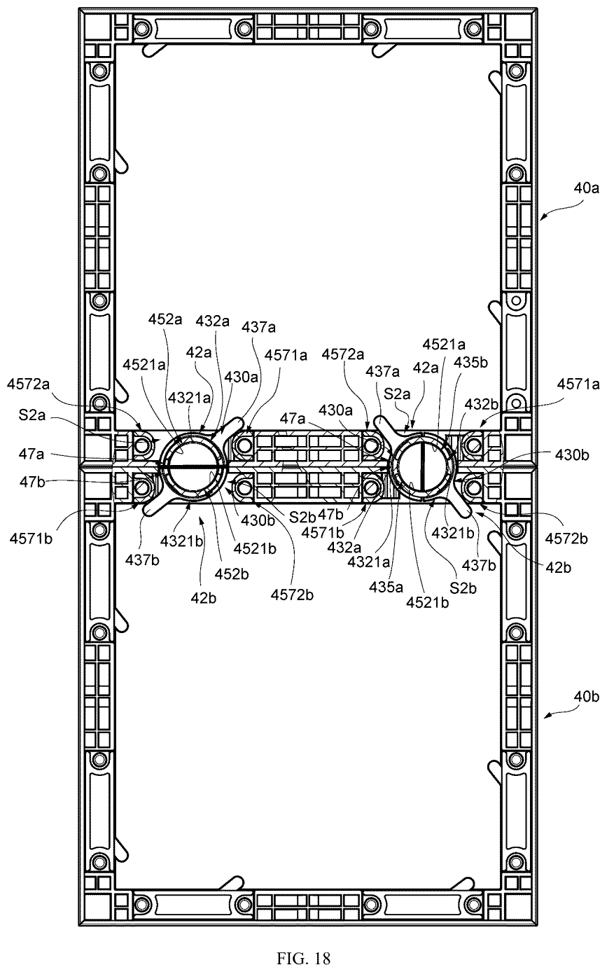

As shown in FIG. 16, the knob 437 is provided so as to extend from the peripheral edge of the main body part 430. In the assembled state, as shown in FIG. 18, the knob 437 extends through the second opening 48 to the outside of the holding space S2, and is provided so as to be able, by rotating, to come into contact with the two ends of the second opening 48 (that is, the first end part 4571 and the second end part 4572 of the first support 45 (discussed below)).

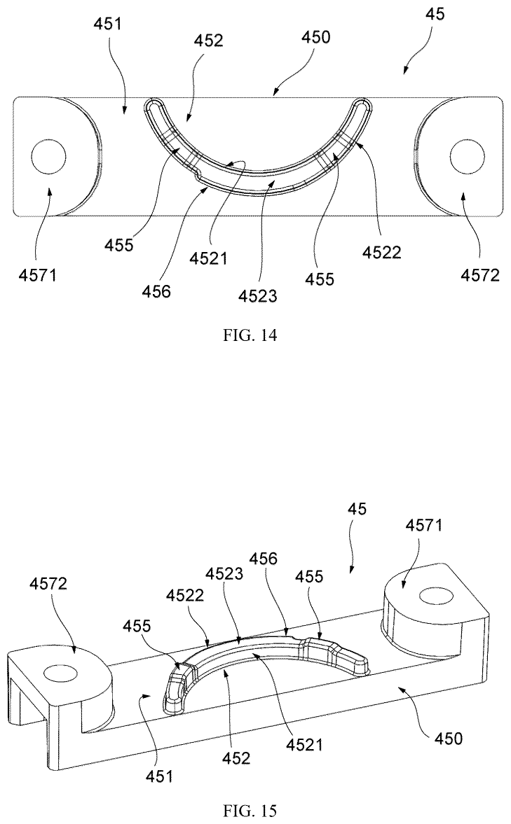

As shown in FIGS. 14 and 15, the first support 45 has a main body part 450, a second surface 451 facing the first surface 431 of the rotating part 43 in the assembled state, a second part 452 that is a raised past corresponding to the first part 432 provided on the second surface 451, and a cylindrical first end part 4571 and second end part 4572 provided at the two ends of the second surface 451.

The second part 452 is a protrusion that can be inserted into the first part 432 and has a substantially semicircular ring shape in plan view. As shown in FIGS. 14 and 15, the second part 452 has a second side surface 4521, a fourth side surface 4522 opposing the second side surface 4521, and a bottom surface 4523 linking the second side surface 4521 and the fourth side surface 4522. As shown in FIG. 17, the second side surface 4521 is in contact with the first side surface 4321 of the first part 432. The second side surface 4521 is arc-shaped in plan view. Also, the curvature of the second side surface 4521 in plan view is the same as the curvature of the first side surface 4321 in plan view. The curvature of the second side surface 4521 in plan view may be slightly greater than the curvature of the first side surface 4321 in plan view.

Also, as shown in FIGS. 14 and 15, two second bottom surface stoppers 455 that are raised parts are provided on the bottom surface 4523 of the second part 452, and a second side surface stopper 456 that is a raised part is provided on the fourth side surface 4522. The second bottom surface stopper 455 and the second side surface stopper 456 are examples of a second stopper.

In the assembled state, the first part 432 and the second part 452 are configured to rotatably engage. More specifically, the first part 432 is provided so as to be rotatable relative to the second part 452 when the first side surface 4321 smoothly slides along the second side surface 4521.

Next, the characteristics of the linking parts 42 of the prize support units will be described in detail using an example of the linking between the prize support units. In the following description, in order to distinguish between two prize support units 40, one prize support unit 40 shall be called the prize support unit 40a, and the other prize support unit 40 the prize support unit 40b. When the openings 47a of the linking parts 42a of the prize support unit 40a are disposed so as to communicate with the openings 47b of the linking parts 42b of the other prize support unit 40b, as shown in FIG. 18, the plan view shape of the second side surface 4521a of the second part 452a of the linking parts 42a and the plan view shape of the second side surface 4521b of the second part 452b of the linking parts 42b are configured to be located on a single circle. Similarly, in this case, the plan view shape of the first side surface 4321a of the first part 432a of the linking parts 42a and the plan view shape of the first side surface 4321b of the first part 432b of the linking parts 42b are also configured to be located on a single circle.

With the configuration described above, when the prize support unit 40a and the prize support unit 40b are linked, the first part 432a of the linking part 42a rotates smoothly along the second side surface 4521a of the linking part 42a and the second side surface 4521b of the linking part 42b, goes smoothly into the holding space S2b of the other prize support unit 40b, and can engage with the second part 452b of the linking part 42b. In this case, the first part 432a of the linking part 42a is configured so that one portion thereof maintains engagement with the second part 452a of the linking part 42a, and another portion thereof engages with the second part 452b of the linking part 42b. Similarly, the first part 432b of the linking part 42b is configured so that one portion thereof maintains engagement with the second part 452b of the linking part 42b, and portion thereof engages with the second part 452b of the linking part 42b. As a result, one prize support unit 40a and the other prize support unit 40b can be securely linked together by the linking parts 42a and the linking parts 42b.

Also, by rotating the first part 432a of the linking part 42a, the knob 437a can come into contact with the first end part 4571a or the second end part 4572a, which constitute the two ends of the second opening 48a. When the knob 437a hits the first end part 4571a, the main body part 430a of the linking part 42a is entirely housed within the holding space S2a, as shown in FIGS. 10 and 18. Meanwhile, when the knob 437a hits the second end part 4572a, the main body part 430a of the linking part 42a is configured so that one half maintains its engagement with the second part 452a, and the other half can engage with the second part 452b of the other prize support unit 40b, as shown in FIGS. 11 and 18. The same holds true for the main body part 430b of the linking part 42b. With this configuration, one prize support unit 40a and the other prize support unit 40b can be linked together more stably.

Also, when the knob 437a hits the second end part 4572a, that is, when the respective halves of the linking parts 42a and the linking parts 42b are fitted together, the stoppers of the linking parts 42a and the linking parts 42b hit the corresponding stoppers. More specifically, in this case, although not depicted in the drawings, with the stoppers of the linking parts 42a, the first bottom surface stopper 435a on one side of the linking part 42a hits the second bottom surface stopper 455a, the first bottom surface stopper 435a of the other side of the linking part 42a hits the second bottom surface stopper 455b, and the first side surface stopper 436a of the linking part 42a hits the first side surface stopper 436a and the second side surface stopper 436b. The same holds true for the stopper of the linking part 42b. When the stoppers hit each other in this way, this stops the rotation of first part 432 relative to second part 452. As a result, the rotation of the rotating part 43 can be locked.

### Prize Drop Opening 5

The prize drop opening 5 will now be described with reference to FIGS. 2 and 3.

The prize drop opening 5 is configured to allow the game space S and the prize accommodating unit 11 to communicate. As shown in FIGS. 2 and 3, the prize drop opening 5 has a first drop opening 51 formed on the front side of the prize support plate 4, and a second drop opening 52 that is formed on the lower side of the first drop opening 51 and the prize support plate 4 and allows the first drop opening 51 and the prize accommodating unit 11 to communicate.

The size of the first drop opening 51 can be adjusted by changing the way the prize support units 40 of the prize support plate 4 are combined. As shown in FIG. 3, the second drop opening 52 is provided with a drop detector 53 that detects the dropping of a prize. This drop detector 53 affords accurate detection of whether the user has acquired a prize.

### Prize Acquisition Unit 6

Next, the prize acquisition unit 6 will be described in detail with reference to FIG. 1 and FIGS. 19 to 21.

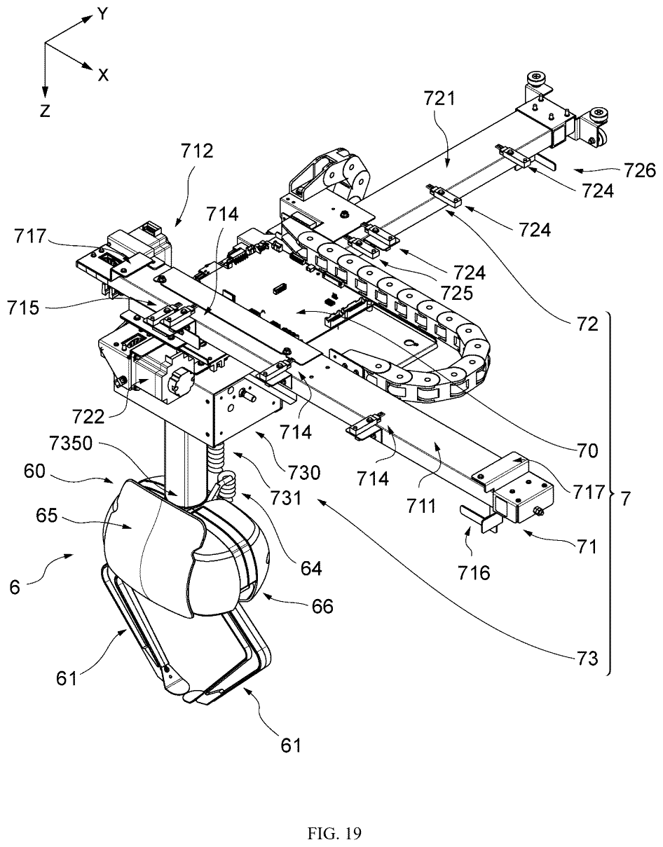

The prize acquisition unit 6 is a device (or prize acquisition device) configured to move within the game space S and grasp a prize that has been placed on the prize support plate 4. The prize acquisition unit 6 is provided within the game space S so as to be suspended from the drive unit 7. As shown in FIG. 19, the prize acquisition unit 6 has a main body part 60 that is provided movably in the game space S, and the pair of arms 61 that are provided so as to be able to move in conjunction with the movement of the main body part 60 and relative to the main body part 60. Here, the pair of arms 61 are an example of arms for acquiring a prize. Also, the number of arms 61 is not limited to two. For example, the arm may be a single arm provided so as to hook onto a prize, or may be three or more arms provided so as to pinch a prize. The main body part 60 is connected to the drive unit 7, and the pair of arms 61 extend downward from the main body part 60. In the following description, the movement of the main body part 60 and the pair of arms 61 will sometimes be referred to as “movement of the prize acquisition unit 6.”

As shown in FIGS. 19 to 21, the main body part 60 has a housing 66, an attachment part 62 provided inside the housing 66 for attaching the prize acquisition unit 6 to the drive unit 7, and an arm drive unit (or arm driver) 63 that drives the opening and closing movement of the pair of arms 61. Here, the opening and closing movement of the pair of arms 61 is an example of arm movement, and includes when the pair of arms 61 move away from each other to open and when the pair of arms 61 move closer together to close. The pair of arms 61 may perform movement other than opening and closing.

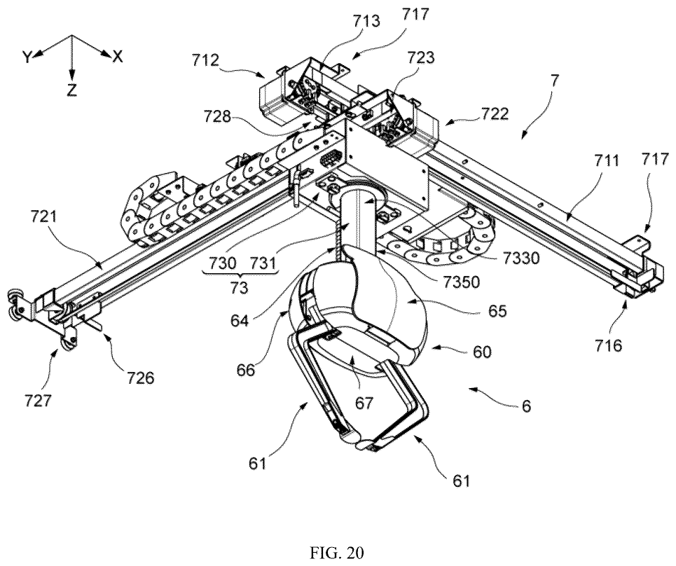

The arm drive unit 63 is attached to the attachment part 62, and power is supplied thereto by a cable 64. The bottom part of the housing 66 constitutes the bottom part 67 of the main body part 60 as shown in FIG. 20. On the bottom part 67 is mounted a bottom sensor (not shown) capable of sensing the pressure that the bottom part 67 of the main body part 60 exerts on the prize. The bottom sensor may include, for example, a known pressure sensor, contact sensor, distance measurement sensor, or the like. As shown in FIGS. 1 and 19, the main body part 60 also has a display part 65 for displaying a design sheet or the like formed on the front surface portion of the housing 66. Displaying a design sheet improves the aesthetic appearance of the main body part 60.

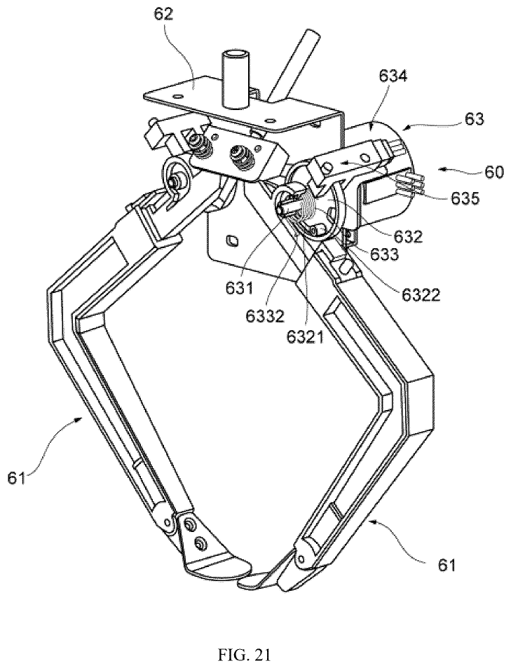

As shown in FIG. 21, the arm drive unit 63 has a rotation shaft 631 that is fixed to the attachment part 62 and rotatably supports the arms 61, a gripping force action gear 632 that is rotatably attached to the rotation shaft 631, a coil spring 633 that is wound around the rotation shaft 631, a motor 634 that drives the rotation of the gripping force action gear 632, and an opening degree sensor 635 that senses the degree of opening of the arms 61.

The motor 634 has an output shaft to which is fitted a pinion gear (not shown). The gripping force action gear 632 is a disk-shaped gear that meshes with a pinion gear on the motor 634 side. The gripping force action gear 632 has an arc-shaped slot 6321 of a specific length provided on its peripheral edge, and a boss 6322 provided on one main surface in the thickness direction. The coil spring 633 is attached to the gripping force action gear 632 and the arms 61 such that one end (not shown) is loosely inserted into the slot 6321 so as to be freely movable, and the other end 6332 is fixed to the arms 61. The gripping force action gear 632 and the arms 61 are configured so that they can be interlocked by the coil spring 633.

The arm drive unit 63 drives the pair of arms 61 to open and close in order to grasp or release a prize. More specifically, under the control of the controller 15, the motor 634 outputs a rotational force in a specific direction, and transmits this rotational force to the gripping force action gear 632 through the output shaft and pinion gear, thereby rotating the gripping force action gear 632. The rotation of the gripping force action gear 632 is transmitted to the arms 61 through the coil spring 633, causing the arms 61 to rotate open. After this, when the gripping force action gear 632 stops rotating, the arms 61 continue to rotate due to the spring force of the coil spring 633 until stopping after making contact with the boss 6322. In this way, the arm drive unit 63 can open the pair of arms 61 to a preset degree of opening via the output shaft, the pinion gear, the gripping force action gear 632, and the coil spring 633 under the operation of the motor 634.

Meanwhile, when the pair of arms 61 are to be closed, the motor 634 outputs a rotational force in the opposite direction from the specific direction under control by the controller 15. Then, the arm drive unit 63 can close the pair of arms 61 via the output shaft, the pinion gear, the gripping force action gear 632, and the coil spring 633 under the reverse operation of the motor 634.

The opening degree sensor 635 is a sensor which senses the rotation angle of the gripping force action gear 632 and thereby senses the degree of opening of the pair of arms 61. When the opening degree sensor 635 senses the degree of opening of the arms 61, this information is transmitted to the controller 15. When the controller 15 detects that the opening degree information for the arms 61 transmitted from the opening degree sensor 635 has reached the set degree of opening, it stops the rotation of the gripping force action gear 632. This allows the degree of opening of the pair of arms 61 to be maintained at the set value. Also, when the controller 15 detects that the opening degree information for the arms 61 transmitted from the opening degree sensor 635 has moved beyond a specific threshold value, it stops the movement of the main body part 60. This allows the movement of the pair of arms 61 along with the main body part 60 to be stopped.

Here, the above-mentioned set degree of opening and the specific threshold value related to that degree of opening are both initial information that is stored in a storage unit (or storage) 13. The specific threshold value for the degree of opening is greater than the set degree of opening. For example, the specific threshold value for the degree of opening may be 90 degrees, and the set degree of opening may be an angle that is less than 90 degrees. The set degree of opening and the specific threshold value related to the degree of opening can both be changed in the settings.

Also, the set degree of opening is the degree of opening when the pair of arms 61 have been moved from their closed state to their open state for obtaining a prize under the control of the controller 15 before the approach movement in which the main body part 60 approaches the prize in the approach direction and when the main body part 60 is stopped at the approach starting point (discussed below). Under the control of the controller 15, when the pair of arms 61 receive just the drive force of the arm drive unit 63, the pair of arms 61 will not be opened to a degree greater than the set degree of opening.

Meanwhile, as the approach movement of the main body part 60 progresses, one or both of the pair of arms 61 may come into contact with a prize or the prize support plate 4, resulting in movement beyond the specific threshold value. If such contact occurs, and the approach movement of the main body part 60 continues, the arms 61 will make contact with the side surface of the housing 66 due to rebound from the prize or the prize support plate 4, and exert a large amount of pressure on the prize or the prize support plate 4 together with the main body part 60. If this should happen, the pressure exerted by the arms 61 and the main body part 60 on the prize or the prize support plate 4 is the combination of at least a portion of the weight of the arms 61 and the weight of the main body part 60. By contrast, if such contact occurs and the approach movement of the main body part 60 is halted, the pressure exerted on the prize or the prize support plate 4 will be just the weight of the arms 61, so the pressure exerted on the prize or the prize support plate 4 by the prize acquisition unit 6 can be reduced as compared to when the approach movement of the main body part 60 is not stopped.

Also, the prize acquisition unit 6 can move in the X direction, the Y direction, and the Z direction within the game space S. Here, the Z direction includes the direction facing downward (hereinafter referred to as the “Z direction descent direction”) and the direction facing upward (hereinafter referred to as the “Z direction ascent direction”). The Z direction descent direction is an example of an approach direction for approaching a prize, and the Z direction ascent direction is an example of a retreat direction, which is the opposite direction from the approach direction. In the following, movement along the Z direction descent direction will be referred to as “approach movement,” movement along the Z direction ascent direction will be referred to as “retreat movement,” and if no distinction is made between the two, they may be collectively referred to as “Z direction movement.” Also, when no distinction is to be made in the X direction movement and/or the Y direction movement of the prize acquisition unit 6, the two may be collectively referred to as “planar movement.” Also, the position where the prize acquisition unit 6 stops before the game starts is sometimes called the “standby position,” and the position of the prize acquisition unit 6 after it has undergone planar movement but before it starts approach movement is sometimes called the “approach starting point.”

The prize acquisition unit 6 is configured to perform Z direction movement after performing planar movement, for example. Also, the planar movement of the prize acquisition unit 6 is performed at the user's discretion, while the Z direction movement of the prize acquisition unit 6 is performed based on the initial settings, regardless of the user's intentions. In addition, if the operation part 83 includes the third button 833 related to movement in the Z direction (see the example shown in FIG. 5), the Z direction movement of the prize acquisition unit 6 can be performed at the user's discretion, that is, when the user operates the third button 833.

The movement of the prize acquisition unit 6 will now be described in greater detail. The movement of the prize acquisition unit 6 in the X direction and the Y direction is realized either by a first method, in which the administrator of the prize acquisition game device 1 manually moves the prize acquisition unit 6 in administration mode, or a second method, in which the controller 15 moves the prize acquisition unit 6 based on a movement request inputted by the administrator of the prize acquisition game device 1 in administration mode or by a player operating the first button 831 and the second button 832 of the operation part 83 in game mode.

The first method is a method used to determine the standby position, movement range, and prize insertion position of the prize acquisition unit 6. Here, the standby position of the prize acquisition unit 6 is the origin of the coordinate space (XYZ space) in which the prize acquisition unit 6 can move. The origin may be a different position from the standby position. The movement range is the range over which the prize acquisition unit 6 can move in the XY plane of the coordinate space. The prize insertion position is the position where the prize acquisition unit 6 is above the prize drop opening 5 so that the prize can be inserted into the prize drop opening 5. Also, after the prize acquisition unit 6 has been moved to the standby position by the first method, the coordinates of the point corresponding to the position of the prize acquisition unit 6 are automatically acquired by the position sensor and encoder of the drive unit 7 (that is, the X direction origin sensor 715 and the X direction position sensor 714, and/or the Y direction origin sensor 725 and the Y direction position sensor 724, and the first encoder 713 and the second encoder 723 (discussed below)). The same holds true for the acquisition of the coordinates of the points corresponding to the movement range and the prize insertion position. With this first method, the administrator can easily acquire, change, etc., the origin, the standby position, the movement range, and the prize insertion position.

The second method is a method used in the acquisition of a prize by the prize acquisition unit 6. When the second method is used, the drive unit 7 drives the movement of the prize acquisition unit 6 in the X direction and/or the Y direction under the control of the controller 15. Also, just as in the first method, after the prize acquisition unit 6 has been moved by the second method, the coordinates of the point corresponding to the position of the prize acquisition unit 6 are automatically acquired by the position sensors and encoders of the drive unit 7. With this second method, the administrator and the player can freely move the prize acquisition unit 6 and can acquire the coordinates of a point on the movement path of the prize acquisition unit 6.

Also, when either the first method or the second method is used, the prize acquisition unit 6 is moved along the rails of the drive unit 7 (first rail 711 and/or second rail 721 (discussed below)). The rails of the drive unit 7 are provided so that their lengthwise direction is parallel to the prize support surface 401. Consequently, the prize acquisition unit 6 can move in a specific plane 601 (see FIG. 1) whose center of gravity is parallel to the prize support surface 401.

The approach movement of the prize acquisition unit 6 is a movement that is automatically performed along the Z direction descent direction after a specific planar movement is performed in order to approach and grasp a prize. Also, the approach movement of the prize acquisition unit 6 is a movement driven by the drive unit 7 under the control of the controller 15. More specifically, after the prize acquisition unit 6 undergoes planar movement, that is, after stopping at the approach starting point in a specific plane 601 of the prize acquisition unit 6, under the control of the controller 15, the arm drive unit 63 opens the integrated arms 61 to a set degree of opening, and the drive unit 7 then drives the approach movement of the prize acquisition unit 6 based on the initial setting. After this, when the arms 61 of the prize acquisition unit 6 have moved beyond a specific threshold value, or when the bottom sensor detects that the bottom part 67 of the main body part 60 of the prize acquisition unit 6 has pressed against a prize with a specific pressure, the approach movement of the main body part 60 is stopped. After this, under the control of the controller 15, first pressure adjustment is performed to adjust the pressure applied by the arms 61 to the prize or the prize support unit 40, or second pressure adjustment is performed to adjust the pressure applied by the main body part 60 to the prize.

Here, the first pressure adjustment is performed to reduce the pressure applied by the arms 61 to the prize or prize support unit 40 by stopping the approach movement of the main body part 60 when the arms 61 of the prize acquisition unit 6 have moved beyond a specific threshold value. The second pressure adjustment is performed by adjusting the positions of the bottom part 67 of the main body part 60 and the prize. More specifically, in this adjustment, when the bottom sensor detects that the bottom part 67 of the main body part 60 has pressed against the prize with a specific pressure, the approach movement of the main body part 60 is stopped, and the main body part 60 is then moved a first distance in the retreat direction and then stopped again, thereby reducing the pressure exerted by the main body part 60 on the prize.

Also, the first distance related to the second pressure adjustment is a distance that can reduce the pressure exerted by the main body part 60 on the prize to a specific value while maintaining contact between the bottom part 67 of the main body part 60 and the prize, an example being a few millimeters. The first distance is determined by the controller 15 so as to reduce the pressure exerted by the main body part unit 60 on the prize to a specific value while maintaining contact between the bottom part 67 of the main body part 60 and the prize, depending on the type of prize. This first distance allows the pressure exerted by the main body part 60 on the prize to be reduced while maintaining a state in which the orientation of the main body part 60 relative to the prize remains almost unchanged. This diminishes the effect that the second pressure adjustment has on the prize acquisition operation. In addition, a bottom sensor including a contact sensor or distance measurement sensor mounted on the bottom part 67 may be used to reduce the pressure exerted by the arms 61 on the prize or prize support unit 40 before pressure is applied to the prize.

The opening and closing of the pair of arms 61 varies with changes to the position of the prize acquisition unit 6 under the control of the controller 15. More specifically, the pair of arms 61 are closed when the prize acquisition unit 6 is in the standby position, open at a set degree of opening after the prize acquisition unit 6 moves to the approach starting point via planar movement, close so as to grasp the prize after the prize acquisition unit 6 performs approach movement and stops, open so as to release the grasped prize after the prize acquisition unit 6 moves to the prize insertion position via retreat movement, and then reclose. After this, the prize acquisition unit 6 returns to the standby position while the pair of arms 61 are still closed.

### Drive Unit 7

Next, the drive unit 7 will be described in detail with reference to FIG. 1 and FIGS. 19 to 28.

The drive unit 7 is configured to support the prize acquisition unit 6 so as to be suspended from the drive unit 7, and to drive the prize acquisition unit 6 in a specific plane 601 of the game space S based on control by the controller 15. The drive unit 7 has a first drive unit (or first driver) 71 that drives movement of the prize acquisition unit 6 in the X direction, a second drive unit (or second driver) 72 that drives movement of the prize acquisition unit 6 in the Y direction, and a third drive unit (or third driver) 73 that drives movement of the prize acquisition unit 6 in the Z direction. Also, the drive unit 7 is configured to be able to communicate with the controller 15, and has a control board 70 that, along with the controller 15, controls the electrical configuration of each of the first drive unit 71, the second drive unit 72, and the third drive unit 73.

The first drive unit 71 has a first rail 711, a first motor 712 and a first encoder 713 provided on one end of the first rail 711, an X direction origin sensor 715 and three X direction position sensors 714 provided along the lengthwise direction of the first rail 711, dogs 716 provided at both ends of the first rail 711, and an attachment component 717 that is provided at both ends of the first rail 711 and is used for attaching the first rail 711 to the support 34.

The first rail 711 is provided so as to be movable with respect to the support 34 in the width direction, by attachment of the roller of the first drive unit 71 and the rail 341 of the support 34. Since the first rail 711 is provided so that its lengthwise direction is parallel to the prize support surface 401, the lengthwise direction of the first rail 711 corresponds to the X direction of movement of the prize acquisition unit 6.

The first motor 712 is configured to move the second drive unit 72 and the third drive unit 73 along the first rail 711 (that is, in the X direction), and thereby realize movement of the prize acquisition unit 6 attached to the third drive unit 73 in the X direction. The first encoder 713 is configured to sense the distance traveled by the prize acquisition unit 6 in the X direction by sensing the rotational state of the first motor 712 (such as the rotational movement amount and angle of the first motor 712). This first encoder 713 allows the distance traveled by the prize acquisition unit 6 in the X direction to be accurately sensed with a simple configuration.

The X direction origin sensor 715 and the three X direction position sensors 714 are examples of position sensors that sense the position of the prize acquisition unit 6, that is, the coordinates of a specific point on the movement path of the prize acquisition unit 6. The X direction origin sensor 715 is a sensor that, together with the Y direction origin sensor 725 (discussed below), senses the standby position of the prize acquisition unit 6 as the origin. Acquiring the origin coordinates makes it possible to determine the coordinate space (XYZ space) in which the prize acquisition unit 6 is located. Here, the standby position of the prize acquisition unit 6 is above the front end of the game space S. Also, the standby position of the prize acquisition unit 6 is a position specified by the administrator of the prize acquisition game device 1 by manually moving the prize acquisition unit 6.

The three X direction position sensors 714 are sensors that sense the X coordinate of points on the movement path of the prize acquisition unit 6. The two dogs 716 are detection pieces provided at both ends of the movement range of the prize acquisition unit 6 in the X direction. These two dogs 716 allow the prize acquisition unit 6 to move within the movement range in the X direction.

The second drive unit 72 has a second rail 721, a second motor 722 provided at one end of the second rail 721, a second encoder 723 that senses the rotational state of the second motor 722, a Y direction origin sensor 725 and three Y direction position sensors 724 provided along the lengthwise direction of the second rail 721, and dogs 726 provided at both ends of the second rail 721. The second drive unit 72 also has rollers 727 provided at both ends of the second rail 721 for movably attaching to a rail 342 of the support 34, and an attachment part 728 for movably attaching to the first rail 711.

The second rail 721 is provided so as to be movable with respect to the support 34 and the drive unit 71 in the depth direction by means of attachment of the rollers 727 and the rail 342 of the support 34, and the attachment of the attachment part 728 and the first rail 711. Since the second rail 721 is provided so that its lengthwise direction is parallel to the prize support surface 401, the lengthwise direction of the second rail 721 corresponds to the Y direction of movement of the prize acquisition unit 6.

The second motor 722 is configured to move the third drive unit 73 and the first drive unit 71 along the second rail 721 (that is, in the Y direction), thereby realizing movement in the Y direction of the prize acquisition unit 6 attached to the third drive unit 73. The second encoder 723 is configured to sense the distance traveled by the prize acquisition unit 6 in the Y direction by sensing the rotational state of the second motor 722 (such as the rotational movement amount and angle of the second motor 722). With this second encoder 723, the distance traveled by the prize acquisition unit 6 in the Y direction can be accurately sensed with a simple configuration.

The Y direction origin sensor 725 and the three Y direction position sensors 724 are examples of position sensors that sense the position of the prize acquisition unit 6, that is, the coordinates of a specific point on the movement path of the prize acquisition unit 6. The Y direction origin sensor 725 is a sensor that, along with the X direction origin sensor 715, senses the standby position of the prize acquisition unit 6 as the origin. The three Y direction position sensors 724 are sensors that sense the Y coordinate of points on the movement path of the prize acquisition unit 6. The two dogs 726 are detection pieces provided at both ends of the movement range of the prize acquisition unit 6 in the Y direction. These two dogs 726 allow the prize acquisition unit 6 to move within the movement range in the Y direction.

The third drive unit 73 has a main body part 730 and a support 731 that supports the prize acquisition unit 6 so that it can be raised and lowered.

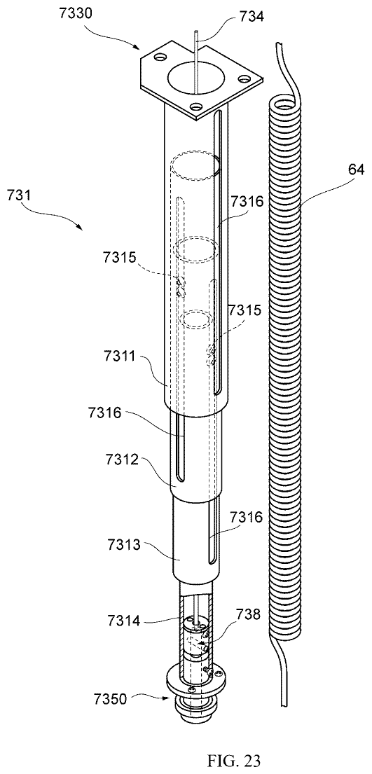

As shown in FIG. 23, the support 731 is a stretchable pipe formed by fitting four pipes 7311, 7312, 7313, and 7314 having successively smaller diameters in a nested manner so as to be freely slidable. The pipes 7311, 7312, 7313, and 7314 are configured so as not to rotate relative to one another or to come loose due to engagement between stoppers 7315 provided at the peripheral surfaces of the pipes and grooves 7316. The support 731 also has an upper end part 7330 provided above the pipe 7311 and a lower end part 7350 provided below the pipe 7314. The support 731 allows the prize acquisition unit 6 to be attached to the third drive unit 73 via the connection between the upper end part 7330 and the housing of the main body part 730, and the connection between the lower end part 7350 and the attachment part 62 of the prize acquisition unit 6.

When the prize acquisition unit 6 is positioned in a specific plane 601, the weight of the pipes 7311, 7312, 7313, and 7314 is exerted on the prize acquisition unit 6. Meanwhile, as the approach movement of the prize acquisition unit 6 progresses, the stopper 7315 of the pipe 7312 reaches the lower end of the groove 7316 of the pipe 7311, so that the weight of the pipe 7312 is supported by the pipe 7311, then the weight of the pipe 7313 is supported by the pipe 7312, and then the weight of the pipe 7314 is supported by the pipe 7313.

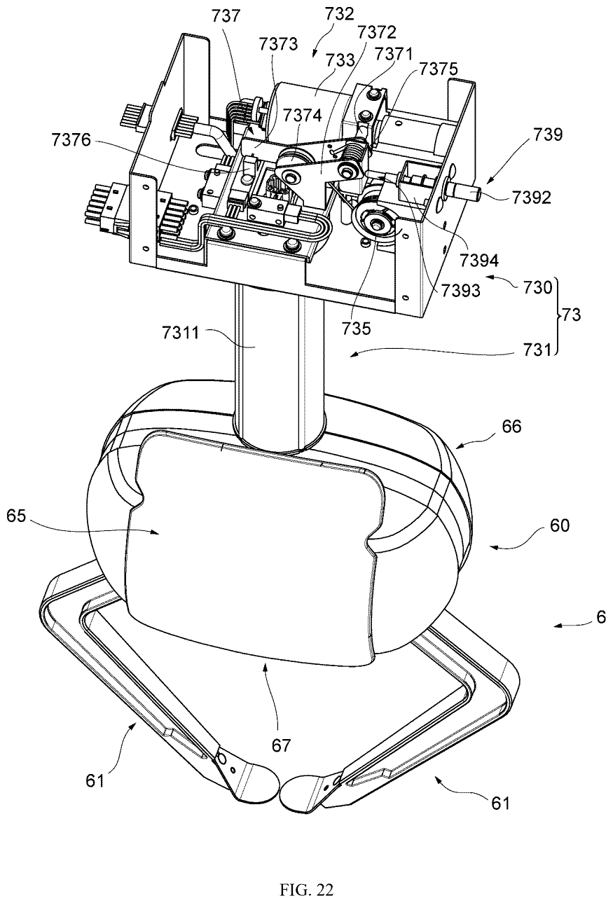

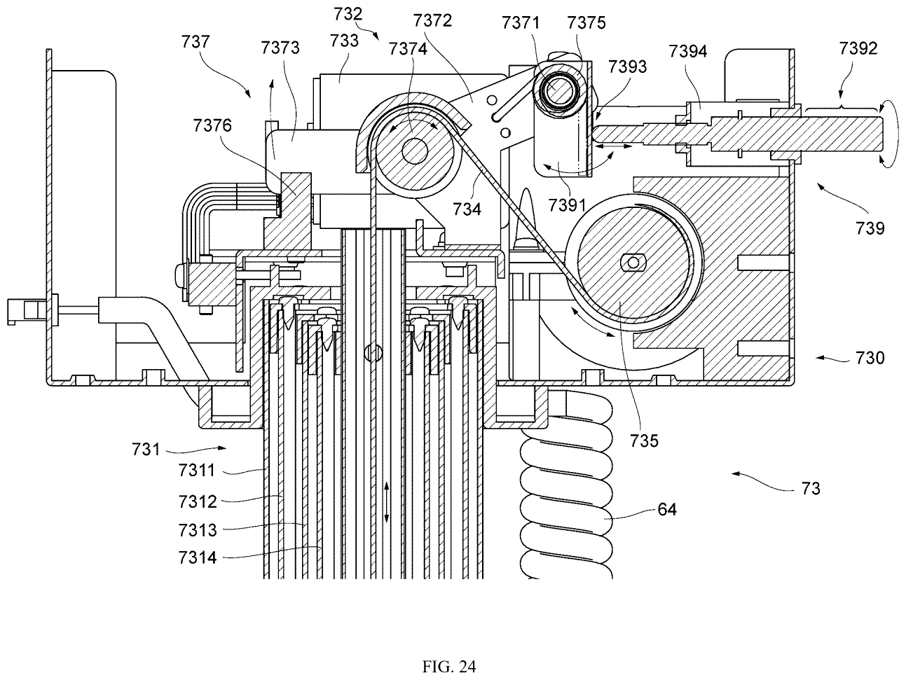

As shown in FIGS. 22 and 24, the main body part 730 has a winding and unwinding part 732 that is attached to the prize acquisition part 6 and is provided inside the housing of the main body part 730, and a wire 734 wound up by the winding and unwinding part 732.

As shown in FIGS. 22 and 24, the winding and unwinding part 732 has a third motor 733, a reduction gear part (not shown), a wire winding pulley 735, a Z direction movement stop part 737, and a biasing force adjustment part 739. The third motor 733 plays out or winds up the wire 734 by rotating the wire winding pulley 735 forward or backward via deceleration of the reduction gear part. By playing out or winding up the wire 734, the prize acquisition unit 6 fixed to the wire 734 can perform approach movement or retreat movement in the Z direction. In this case, the support 731 expands and contracts in the Z direction as the length of the wire 734 changes due to unwinding and winding.

The Z direction movement stop part 737 is configured to stop the Z direction movement of the main body part 60, that is, the approach movement or ascent movement, when the bottom part 67 of the main body part 60 makes contact with a prize and pushes on the prize with a specific pressure due to the approach movement of the main body part 60. The Z direction movement stop part 737 has a dog rotation shaft 7371, a swing arm 7372 that can swing around the dog rotation shaft 7371, a Z direction dog 7373 that is provided at one end of the swing arm 7372 and swings along with the swing arm 7372, a tension pulley 7374 that is rotatably supported by the swing arm 7372, a coil spring 7375 that biases the swing arm 7372 in the lifting direction of the prize acquisition unit 6 so as to press the tension pulley 7374 against the wire 734, an approach stop sensor 7376 for stopping approach movement (descent movement) in the Z direction, and an ascent stop sensor for stopping ascent movement in the Z direction.

One end of the wire 734 is wound up by a wire winding pulley 735 of the winding and unwinding part 732, and the other end is played out from a tension pulley 7374 of the Z direction movement stop part 737 and passes through the inside of the pipes 7311, 7312, 7313, and 7314 of the support 731. Also, as shown in FIG. 23, a cylindrical linking part 738 that is vertically movable within the pipe 7314 is provided at the other end of the wire 734. The wire 734 is fixed to the attachment part 62 of the prize acquisition unit 6 via the linking part 738. Thus, the prize acquisition unit 6 is provided so as to be suspended from the wire 734.

As shown in FIGS. 22 and 24, the biasing force adjustment part 739 is configured to change the biasing force in the lifting direction produced by a coil spring 7375. The biasing force adjustment part 739 has a movable control plate member 7391, an adjustment knob 7392, and a knob support member 7394 that supports the adjustment knob 7392.

The movable control plate member 7391 is a flat member that is rotatably attached to the dog rotation shaft 7371, and is disposed so that the end of the coil spring 7375 comes into contact with it. Here, one end of the coil spring 7375 is hooked on and fixed to the swing arm 7372, and the other end is hooked on the movable control plate member 7391. Accordingly, when the movable control plate member 7391 is rotated around the dog rotation shaft 7371, this changes the biasing force of the coil spring 7375 according to the amount of rotation, that is, the tension of the biasing force when the swing arm 7372 is biased in the lifting direction of the prize acquisition unit 6 by pressing the tension pulley 7374 against the wire 734.

The adjustment knob 7392 is used to change the angle of the movable control plate member 7391, and has a threaded portion that displaces the position of the distal end portion 7393 according to the amount of rotation. The distal end portion 7393 is provided so as to come into contact with the outer surface of the movable control plate member 7391 and press against the repulsive force of the coil spring 7375.

Also, an adjustment knob 7392 is rotatably supported, at two places in one or more embodiments, by a knob support member 7394 attached to the housing of the main body part 730. Since the finger portion of adjustment knob 7392 is located outside of the housing of main body part 730, an administrator can grasp the finger portion from outside the housing of main body part 730 and operate the adjustment knob 7392, making it easy to change the biasing force. Also, the biasing force of the coil spring 7375 can be steplessly varied by using the adjustment knob 7392, which consists of a screw mechanism.

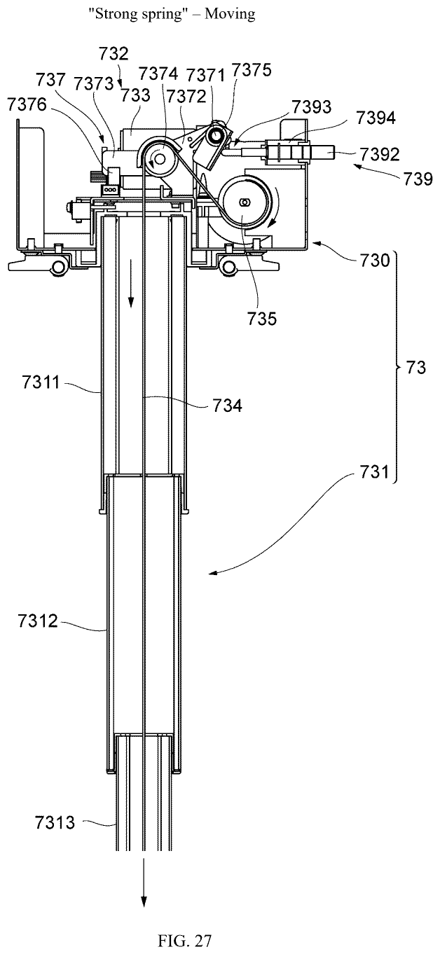

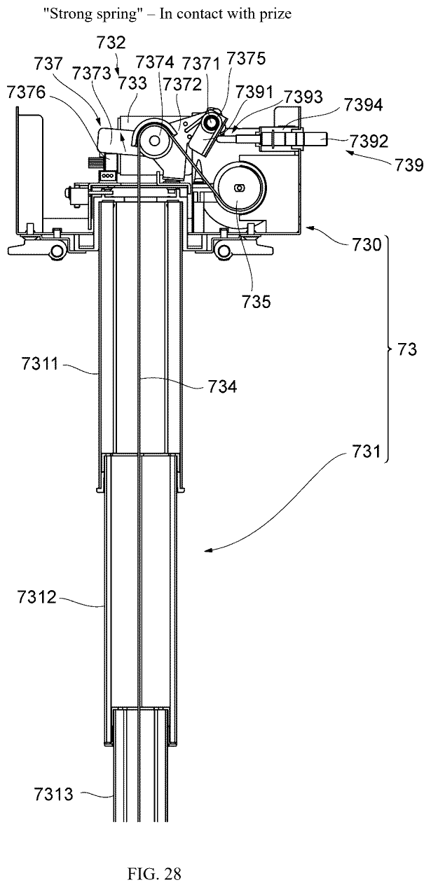

When the adjustment knob 7392 is rotated forward to move the distal end portion 7393 forward, the movable control plate member 7391 is pressed in as shown in FIGS. 27 and 28, and the biasing force of the coil spring 7375 increases to create a “strong spring” state. Consequently, there is an increase in the biasing force of the coil spring 7375 that biases the swing arm 7372 in the lifting direction of the prize acquisition unit 6 and, as a result, there is also an increase in the biasing force in the lifting direction that is exerted on the prize acquisition unit 6 itself via the swing arm 7372 and the wire 734.

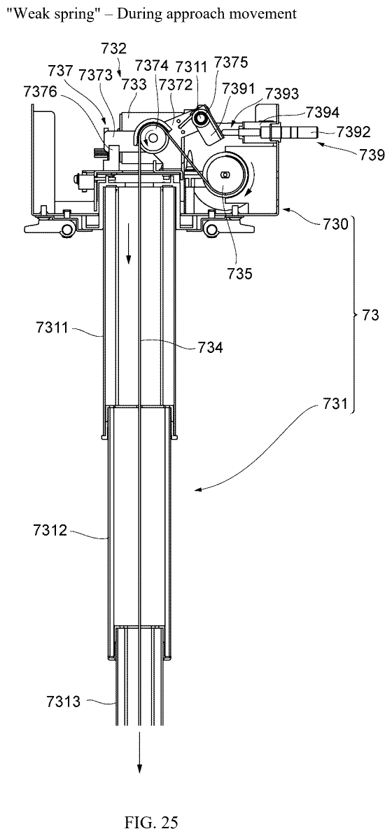

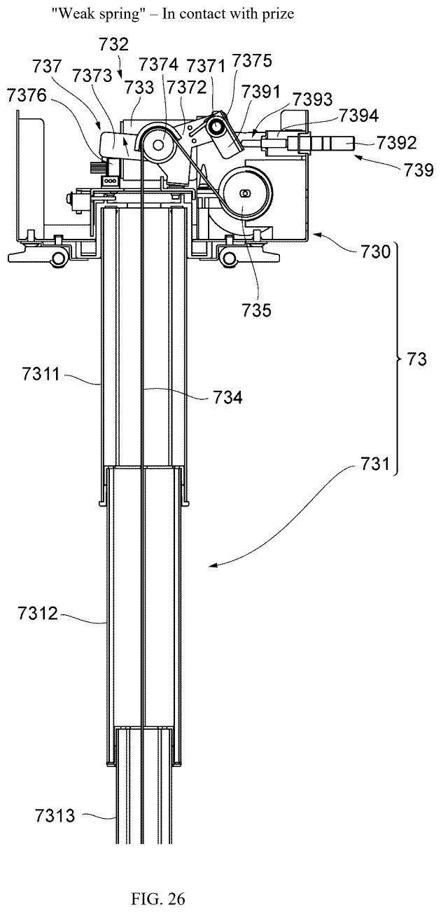

On the other hand, when the adjustment knob 7392 is turned backward to retract the distal end portion 7393, the movable control plate member 7391 returns toward the adjustment knob 7392 as shown in FIGS. 25 and 26, and the biasing force of the coil spring 7375 decreases to create a “weak spring” state. In view of this, the biasing force of the coil spring 7375 that biases the swing arm 7372 in the lifting direction of the prize acquisition unit 6 is reduced and, as a result, there is also a reduction in the biasing force in the lifting direction that is exerted on the prize acquisition unit 6 itself via the swing arm 7372 and the wire 734.

Also, there is a prize acquisition game device with which the size or number of arms 61 can be freely changed in response to changes in the shape and size of the prize, changes in the layout, changes in the position of the prize drop opening 5, and so forth. Changing the size and number of the arms 61 changes the weight of the prize acquisition unit 6. If the weight of the prize acquisition unit 6 changes, the pressing force acting on the prize from the prize acquisition unit 6 can be adjusted by appropriately changing the biasing force of the coil spring 7375.

The approach stop sensor 7376 is a sensor that can send the controller 15 a request to stop the approach movement of the main body part 60 based on the detected state of the Z direction dog 7373 when the main body part 60 is undergoing approach movement. More specifically, when the main body part 60 continues its approach movement and the bottom part 67 of the main body part 60 does not come into contact with a prize, the force in the Z direction descent direction exerted on the wire 734 is greater than the force in the Z direction ascent direction exerted on the wire 734. In this case, the force exerted on the wire 734 in the Z direction descent direction is the combined weight consisting of the weight of the main body part 60, the weight of some or all of the pipes 7311, 7312, 7313, and 7314, and some of the weight of the cable 64. The force exerted on the wire 734 in the Z direction ascent direction is a biasing force in the lifting direction produced by the coil spring 7375. Therefore, the wire 734 is in a taut state as shown in FIG. 25 or FIG. 27. In this case, a Z direction dog 7373 is located to the rear of the approach stop sensor 7376 as shown in FIGS. 24, 25, and 27. Therefore, since the approach stop sensor 7376 detects the Z direction dog 7373, a request to stop the approach movement of the main body part 60 is not sent to the controller 15. As a result, under the control of the controller 15, the third motor 733 continues to drive the wire winding pulley 735, so the main body part 60 continues its approach movement.

On the other hand, when the bottom part 67 of the main body part 60 makes contact with a prize and presses against the prize with a specific pressure, the force exerted on the wire 734 in the Z direction descent direction is less than the force exerted on the wire 734 in the Z direction ascent direction. In this case, the force exerted on the wire 734 in the Z direction descent direction is the combined weight consisting of the weight of the main body part 60, the weight of some or all of the pipes 7311, 7312, 7313, and 7314, and some of the weight of the cable 64. On the other hand, the force exerted on the wire 734 in the Z direction ascent direction is a combination of the biasing force in the lifting direction by the coil spring 7375 and the reaction force against the above-mentioned total weight attributable to the prize. Therefore, the tension applied to the wire 734 is relaxed, as shown in FIG. 26 or 28. Then, the action of the coil spring 7375 causes the Z direction dog 7373 to swing upward along with the swing arm 7372. Consequently, the approach stop sensor 7376 can no longer detect the Z direction dog 7373, and a request to stop the approach movement of the main body part 60 is sent to the controller 15. As a result, under the control of the controller 15, the third motor 733 stops driving the wire winding pulley 735, so the approach movement of the main body part 60 is stopped. Also, immediately after the approach movement of the main body part 60 is stopped, under the control of the controller 15, the third motor 733 resumes driving the wire winding pulley 735, and the main body part 60 moves a first distance in the retreat direction while maintaining contact between its bottom part and the prize, and then stops, so as to reduce the pressure that the main body part 60 exerts on the prize to a specific value.

The ascent stop sensor is a sensor for detecting whether the main body part 60 has returned to a specific point located above in the Z direction (for example, an approach starting point or an arbitrary point in the specific plane 601). When it has been detected that the main body part 60 has returned to a specific point above in the Z direction, the ascent stop sensor sends a request to the controller 15 to stop the ascent movement of the main body part 60. As a result, under the control of the controller 15, the third motor 733 stops driving the wire winding pulley 735, so the ascent movement of the main body part 60 is stopped. On the other hand, when it is not detected that the main body part 60 has returned to a specific point above in the Z direction, the ascent stop sensor does not send a request to the controller 15 to stop the approach movement of the main body part 60. As a result, under the control of the controller 15, the third motor 733 continues to drive the wire winding pulley 735, so the ascent movement of the main body part 60 continues.

In the following description, the X direction origin sensor 715, the three X direction position sensors 714, the Y direction origin sensor 725, and the three Y direction position sensors 724 of the drive unit 7 may be collectively referred to as “position sensors,” the first motor 712, the second motor 722, and the third motor 733 may be collectively referred to as a “motor,” and the first encoder 713 and the second encoder 723 may be collectively referred to as an “encoder.”

### Display Unit 1B

Next, the display unit 1B will be described in detail with reference to FIGS. 1, 7, 8 and 29 to 33. The configuration of the display unit 1B will now be described, followed by a description of the characteristics of the display by the display unit 1B.

### Configuration of Display Unit 1B

The display unit 1B is an example of a configuration for displaying information related to the usage modes of the prize acquisition game device 1, and accepting information inputted by the user from an operation of the display unit 1B. As shown in FIGS. 1 and 7, the display unit 1B is provided between the control panel 82 of the first prize catcher 1F and the control panel 82 of the second prize catcher 1G, in the width direction.

Also, as shown in FIG. 7, the display unit 1B has a display panel 9C, and a first display 9A and a second display 9B that are provided on the display panel 9C and are independent of each other. The first display 9A and the second display 9B are disposed side by side on the left and right in the width direction of the display unit 1B. More specifically, the first display 9A is used in the first prize catcher 1F, and is disposed to the left of the operation unit 8 of the first prize catcher 1F. The second display 9B is used in the second prize catcher 1G, and is disposed to the right of the operation unit 8 of the second prize catcher 1G.

The first display 9A has a first display operation panel 91 and a panel protection part 93 provided on the first display operation panel 91. The second display 9B has a second display operation panel 92 and a panel protection part 93 provided on the second display operation panel 92. Here, the display area of the first display operation panel 91 is an example of a first display area used in the first prize catcher 1F, and the display area of the second display operation panel 92 used in the second prize catcher 1G is an example of a second display area. The first display operation panel 91 and the second display operation panel 92 are constituted by touch panels having the same rectangular shape. When no distinction is to be made between the first display 9A and the second display 9B, they may be referred to collectively as the “display 9,” and when no distinction is to be made between the first display operation panel 91 and the second display operation panel 92, they may be referred to collectively as the “display operation panel 90.”

The first display operation panel 91 and the second display operation panel 92 can perform the same or different displays, under the control of the control unit 1E. Also, the first display operation panel 91 and the second display operation panel 92 can accept touch operation input by the user, and transmit the accepted input to the control unit 1E via the transmission units (or transmitters) of the first display 9A and the second display 9B (not shown).

In the example shown in FIGS. 1 and 7, the display unit 1B is described as having two independent display operation panels, namely, the first display operation panel 91 and the second display operation panel 92, but is not limited to this configuration. For example, the display unit 1B may have one display operation panel, and that one display operation panel may have two independent display areas, that is, a first display area used for the first prize catcher 1F and a second display area used for the second prize catcher 1G.

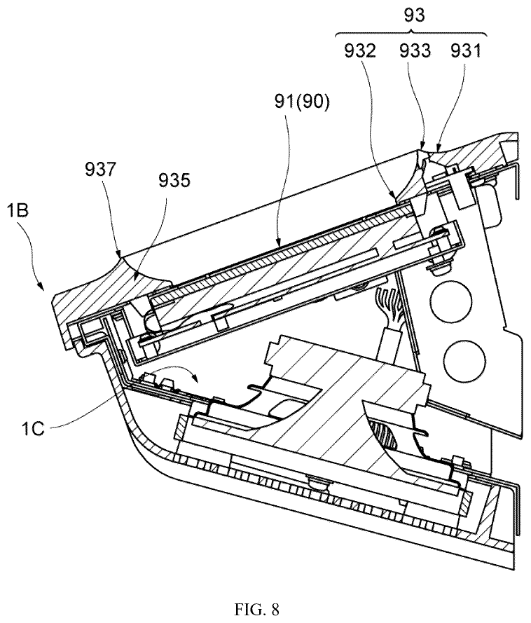

The panel protection part 93 is configured to prevent damage to the display operation panel 90 attributable to excessive pressure being exerted on the display operation panel 90 when the user sits on the display operation panel 90 or forcibly presses on the display operation panel 90 with the palm of their hand. As shown in FIGS. 7 and 8, the panel protection part 93 has a main body part 931, window portions 932 for exposing the two display operation panels 90 provided to the main body part 931, and protrusion portions 933 provided so as to go all the way around the window portions 932.

The main body part 931 and the protrusion portions 933 are formed above the display operation panel 90 in the thickness direction of the display operation panel 90. As shown in FIG. 8, the cross-sectional shape of the protrusion portions 933 is substantially triangular. That is, each protrusion portion 933 rises up from a base portion 925 located on the display operation panel 90 side, becoming thinner toward a distal end portion 937 located on the side away from the display operation panel 90. Also, the distal end portion 937 of the protrusion portion 933 rises up above the top surface of the main body part 931 in the thickness direction of the display operation panel 90.

With the panel protection part 93 having these protrusion portions 933, the distance from the distal end portions 937 of the protrusion portions 933 to the top surface of the display operation panel 90 can be set to be greater than when the protrusion portions 933 are not provided. Consequently, even if the user should sit on the part of the panel protection part 93 corresponding to the display operation panel 90, or forcibly press that part with the palm of their hand, since there is a certain distance from the distal end portions 937 of the protrusion portions 933 to the top surface of the display operation panel 90, this reduces the pressing force on the display operation panel 90 caused by the user's action. Also, since the distal end portions 937 of the protrusion portions 933 are thin, if the user sits on the part of the panel protection part 93 corresponding to the display operation panel 90 or forcibly presses that part with the palm of their hand, the user will feel some pain. Therefore, the presence of distal end portions 937 of the protrusion portions 933 makes it less likely that the user will want to perform one of the above-mentioned actions. As a result, employing the protrusion portions 933 makes it less likely that the panel protection part 93 will be damaged by the user, and the panel protection part 93 can be reliably protected.

In the example shown in FIG. 7, the protrusion portions 933 are provided so as to go all the way around the window portions 932, but this is not the only option. The protrusion portions 933 may be formed only part of the way around the window portions 932, such as on the two sides of the window portions 932 in the width direction.

### Display by Display Unit 1B (Type of Display)

The display by the display unit 1B related to the various usage modes of the prize acquisition game device 1 will now be described. Here, the usage modes include a game mode in which a player plays a prize acquisition game, and an administration mode in which an administrator makes various settings on the prize acquisition game device 1. In game mode, a game screen is displayed on the display operation panel 90, and in administration mode, a settings screen is displayed on the display operation panel 90. Also, a switch to game mode or administration mode is accompanied by a switch to the display of the game screen or the display of the settings screen.

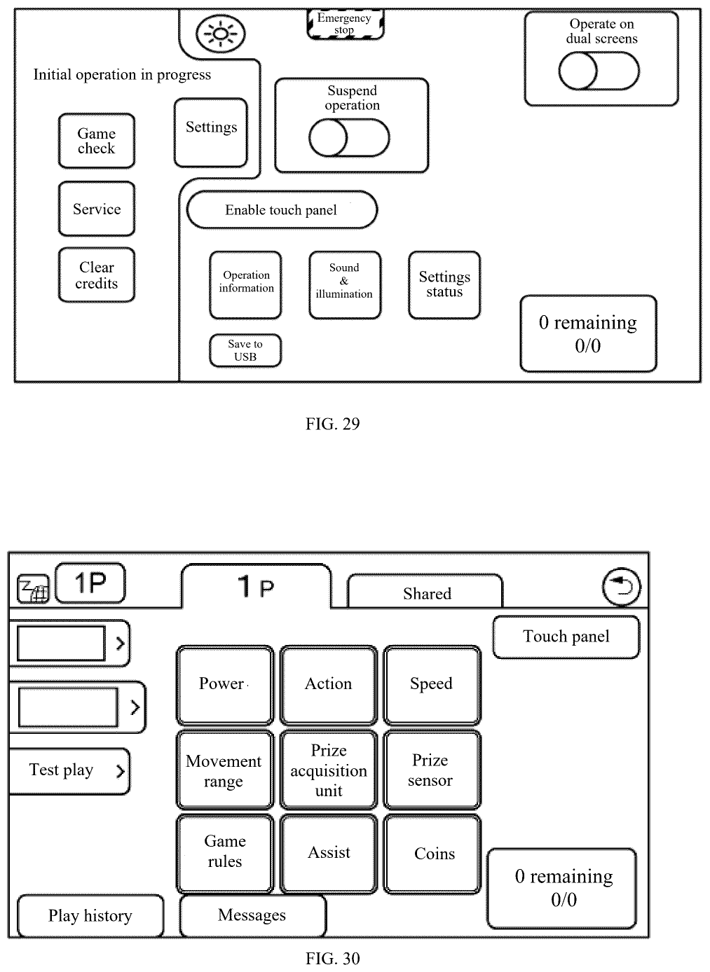

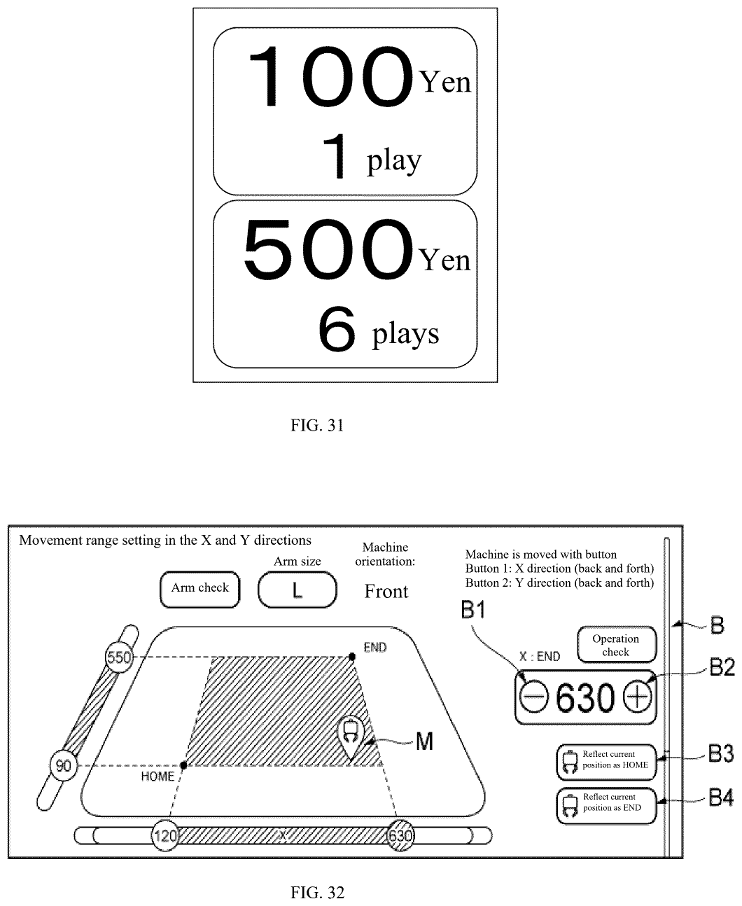

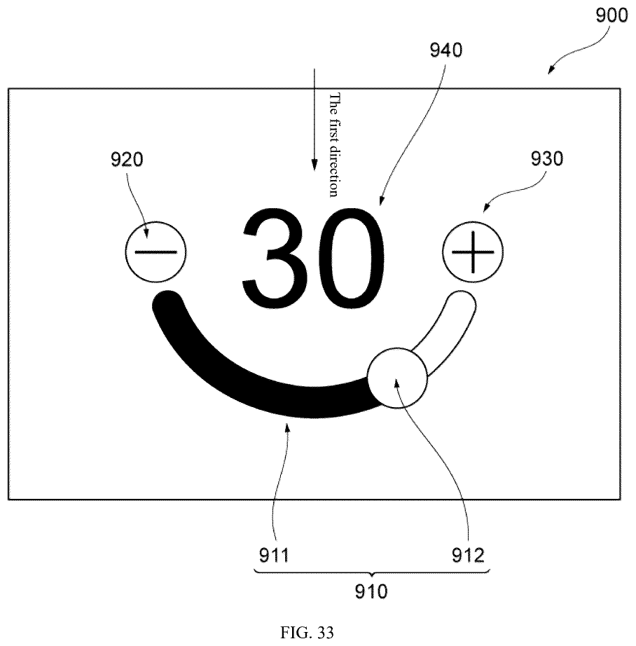

The game screen display includes display of the game fee (for example, FIG. 31), display of the number of times the game can be played, display of play information, and so on. Also, the play information includes movement information about the prize acquisition unit 6 and the play history for each play. The display of the settings screen includes display of a menu screen (for example, FIG. 29), display of operation buttons for changing to a menu screen, display of first menu items included in the menu screen and display of a “dual screen operation” switch (for example, FIG. 29), display of second menu items (for example, FIG. 30), detailed display of the various menu items in the second menu items (for example, FIGS. 32 and 33), display of play information, etc. An operation button is an example of an operation object displayed on the display operation panel 90 for changing to a menu screen.

Next, the relation between the various displays included in the settings screen will be described. In administration mode, when an operation button is displayed on the display operation panel 90, the administrator can change the display on the display operation panel 90 to a menu screen by operating (touching) that operation button. When the menu screen is displayed, if the administrator touches any one of the menu items included in the first menu items, the display on the display operation panel 90 can be changed to a display of the second menu items, and if the administrator further touches one of the menu items included in the second menu items, the display on the display operation panel 90 can be changed to a detailed display of the operated menu item. Also, when the menu screen is displayed, the administrator can turn on the “dual screen operation” switch to implement shared settings for the first prize catcher 1F and the second prize catcher 1G.

Next, the function allocation setting of the multipurpose switch using the “settings status” button among the first menu items of the settings screen, the movement range setting of the prize acquisition unit 6 using the “movement range” button among the second menu items of the settings screen, and the configuration of the “operation reception unit (or operation reception screen) 900” changed by operating the “prize acquisition unit” button among the second menu items of the settings screen, as well as the settings performed by the “operation reception unit 900,” will be described in detail through reference to FIGS. 29, 30, and 32 to 34.

### Function Allocation Setting of the Multipurpose Switch

First, function allocation setting of the multipurpose switch will be described with reference to FIG. 29. When the administrator touches the “settings status” button among the first menu items on the settings screen shown in FIG. 30, the screen showing the first menu items is changed to a screen showing details of the settings information (not shown). The administrator can then check detailed information about the settings on the screen showing the details of the settings information, and can also set the above-mentioned function allocation setting of the multipurpose switch.

Here, the functions of the multipurpose switch include, for example, adding and subtracting credits, pausing the timer, setting the initial position (such as the height in the Z direction) of the prize acquisition unit 6, emergency stopping of the prize acquisition unit 6 (mainly stopping in the Z direction), incrementing the prize payout count, canceling the prize payout notification, and so forth. The function allocation setting of multipurpose switch involves allocating and associating one of the above-mentioned functions of the multipurpose switch to each multipurpose switch.

With a multipurpose switch set in this manner, the administrator can operate the multipurpose switch to perform maintenance such as opening the front panel 31 and changing the prize arrangement within the game space S, and then execute settings and the like that may be entailed by the maintenance that has just been performed. As a result, when the administrator wishes to make further settings after performing maintenance, there is no need to go to the trouble of operating the display operation panel 90 of the display unit 1B or opening the service door 96 to operate the settings unit (or setting device) 99 (discussed below). This greatly reduces the operational burden on the administrator.

Also, when there are a plurality of multipurpose switches, the settings of the functions associated with each of the plurality of multipurpose switches can be performed either by performing function settings for each of the plurality of multiple multipurpose switches individually, or by performing set function settings for some or all of the plurality of multipurpose switches as a group.

Here, the set function settings can be set as one set of functions intended for the user, such as pausing the timer, adding and subtracting credits, and incrementing prize payout count, or can be set as one set of functions intended for management, such as setting the initial position (the height in the Z direction) of the prize acquisition unit 6, emergency stopping of the prize acquisition unit 6 (mainly in the Z direction), incrementing prize payout count, and canceling prize payout notifications. With this type of set function setting, the administrator can select and perform operations on a predefined set to perform a plurality of setting processes included in that set, allowing the administrator to perform settings more easily and reducing the burden required for setting.

### Movement Range Setting

The movement range setting of the prize acquisition unit 6 in the X and Y directions will now be described with reference to FIGS. 30 and 32. When the administrator touches the “movement range” button among the first menu items on the settings screen shown in FIG. 30, the screen showing the first menu items is changed to a screen showing the movement range setting shown in FIG. 32. The administrator can then set the movement range of the prize acquisition unit 6 in the X and Y directions on the screen showing the movement range setting.

More specifically, the administrator can set the movement range of the prize acquisition unit 6 in the X and Y directions by touching and moving a prize acquisition unit mark M, which is in the shape of the prize acquisition unit 6, on the screen showing the movement range setting; by using a minus button B1 and a plus button B2 of the input part shown in the center on the right side of FIG. 32; by using the “reflect current location as HOME” button B3 and the “reflect current location as END” button B4 shown in the lower right side of FIG. 32; or by a combination of these operations.

Here, on the screen showing the movement range setting, the prize acquisition unit mark M indicates the real-time movement and position of the prize acquisition unit 6. In other words, the position of the prize acquisition unit mark M is linked to the actual position of the prize acquisition unit 6. Thus, by operating the prize acquisition unit mark M on the screen showing the movement range setting, the administrator can move the prize acquisition unit 6 in the X and Y directions of the game space S in real time in the same way as the movement of the prize acquisition unit mark M. On the other hand, when the administrator moves the prize acquisition unit 6 by hand or with the operation part 83, etc., the prize acquisition unit mark M also moves in real time in the same manner as the prize acquisition unit 6 on the screen showing the movement range setting.

Also, when the administrator operates the minus button B1 and plus button B2 on the input part, and/or the “reflect current location as HOME” button B3 and the “reflect current location as END” button B4, the prize acquisition unit 6 can be moved in real time in the X and Y directions of the game space S in the same manner as the movement corresponding to the input with these settings buttons B. Also, when the settings button B is operated, the prize acquisition unit mark M also moves in real time in the same manner as the prize acquisition unit 6 on the screen showing the movement range setting. Setting the movement range with the prize acquisition unit mark M or the settings button B in this manner allows the setting of the prize acquisition unit 6 in the X and Y directions of the game space S to be performed more intuitively, which simplifies the administrator's operation of the movement range setting.

### Operation Reception Unit 900

Next, the configuration of the “operation reception unit 900” and the settings performed with the “operation reception unit 900” will be described with reference to FIGS. 30, 33, and 34. When the administrator touches the “prize acquisition unit” button among the second menu items on the settings screen shown in FIG. 30, the screen showing the second menu items is changed to a screen showing the operation reception unit 900 shown in FIG. 33. The administrator can then operate the displayed operation reception unit 900.

Here, the operation reception unit 900 is an example of a configuration for receiving input to move the prize acquisition unit 6 by the touch operation of the user. The operation reception unit 900 has a slide operation part 910, a minus button 920, a plus button 930, and a setting value display 940.

The user can change the parameters of the prize acquisition unit 6 so as to move the prize acquisition unit by operating the slide operation part 910, the minus button 920, the plus button 930, and other reception areas of the operation reception unit 900 (discussed below) for receiving operations from the user. Also, the parameters of the prize acquisition unit 6 include the movement amount of the prize acquisition unit 6 in the X, Y, and Z directions, the movement speed of the prize acquisition unit 6, the opening degree of the two arms 61, the power of the two arms 61, etc.

The slide operation part 910 has a slider 911 and a slider knob 912 that can be moved along the slider 911 when touched by the user. The slider knob 912 is a display object that indicates the movement position of a slide operation, but the color, thickness, etc., of the slider 911 may be displayed differently between areas on the slider 911 where the slide operation has and has not moved, and the boundary between these areas may be represented as the slider knob 912. The slider 911 is in the shape of an arc whose length is greater than the length of a straight line connecting the starting point 913 of the slider 911 and the end point 914 of the slider 911. Also, the slider 911 may have some other shape whose length is greater than the length of one side of the display 9 (more specifically, the short side or long side of the display 9, depending on the disposition of the slider 911). In this case, the slider 911 may be constituted, for example, by a curve or a straight line that is inclined with respect to one side of the display 9, a combination of two or more curves or two or more straight lines, or a combination of straight lines and curves.

Here, it is common knowledge for a slider that is parallel to one side of the display 9 to be displayed on the display 9. The length of this slider parallel to one side of the display 9 is less than or equal to the length of the one side of the display 9. Therefore, if the above-mentioned slider 911 is used in a touch panel of a given size, a longer slider 911 than a slider that is parallel to one side of the display 9 can be formed. Herein, a slider parallel to one side of the display 9 will sometimes be referred to as a “short slider” in order to distinguish it from the slider 911.

In one example, there are a slider 911 and a short slider whose length is half the length of the slider 911. Let us assume that for slider 911, the maximum number of slides the user can make with the slider knob 912 along the slider 911 is 20. In this case, since the length of the short slider is half that of the slider 911, the number of slides the user can make with the slider knob along the short slider 911 is 10. Here, the parameter setting range of the prize acquisition unit 6 is assumed to be “0 to 100.” In this case, if a long slider 911 is used, the maximum number of slides is 20, so when the user makes one slide, the corresponding parameter value is 5. That is, when the long slider 911 is used, the parameter per slide is “5.” By contrast, when a short slider is used, the maximum number of slides is only 10, so when the user makes one slide, the corresponding parameter value is 10. When a short slider is used, the parameter per slide is “10.” Therefore, the numerical value of the parameter corresponding to one slide unit of the long slider 911 is smaller than the numerical value of the parameter corresponding to one slide unit of the short slider. Accordingly, in an operation reception unit 900 of a given size, the slider 911 allows for more precise adjustment of the prize acquisition unit 6 than could be afforded with a short slider.

The setting value display 940 is configured to display a numerical value corresponding to a parameter of the prize acquisition unit 6 by means of input in which the user moves the slider knob 912 along the slider 911, the user touches the minus button 920 or the plus button 930, or the user touches and slides another area of the operation reception unit 900 with a finger or the like.

Also, the operation reception unit 900 has a plurality of reception areas for receiving input from the user over its entire area. The slide operation part 910, minus button 920, and plus button 930 belong to one of a plurality of areas. The reception area to which the slide operation part 910, the minus button 920, and the plus button 930 belong is an arc-shaped area. In the example shown in FIG. 31, the other reception areas of the operation reception unit 900 are also arc-shaped areas. However, the reception areas may be areas of some other shape (such as a rectangular area).

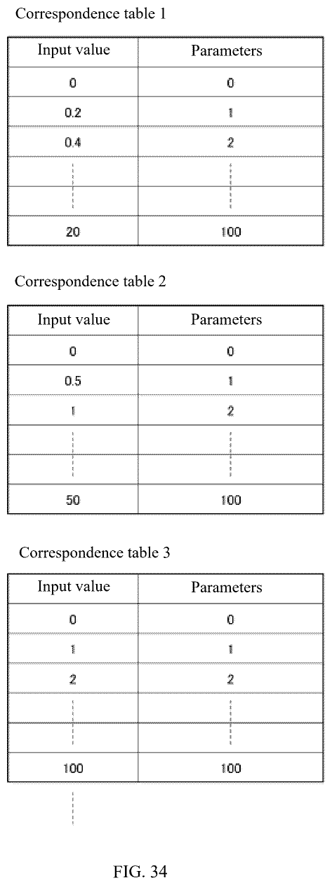

The plurality of reception areas are disposed side by side along the first direction shown in FIG. 33. These reception areas may, however, be aligned in some other direction. The plurality of reception areas have different input/output relationships corresponding to each of the plurality of reception areas. Here, the “input/output relationship” is a relationship in which, when a given input is made to each of the plurality of reception areas, the same input is converted into different outputs corresponding to different reception areas. Converting to different outputs also means that the control unit 1E converts the same inputs made to different reception areas into different numerical value outputs or different parameter outputs based on different input/output relationships corresponding to each of the plurality of reception areas. The input/output relationships of the reception areas are stored in the storage unit 13 of the control unit 1E (discussed below) as a correspondence table relating to the reception area, as shown in FIG. 34. FIG. 34 shows only a part of the correspondence table. With this configuration, operations of different parameters can be easily performed with the same operation reception unit 900, which affords the user greater operation latitude and convenience.

Here, details about the two types of output, that is, the output of different numerical values and the output of different parameters, related to the conversion into different outputs will be described by giving examples. The output of different numerical values means that, for example, if all of the plurality of reception areas correspond to the movement amount among the parameters of the prize acquisition unit 6, when the same input is made to different reception areas, different numerical values for the movement amount of the prize acquisition unit 6 will be outputted. When different numerical values are outputted, the same applies when all of the plurality of reception areas are other parameters among the parameters of the prize acquisition unit 6. Also, converting same inputs made to different reception areas into outputs of different parameters means that, for example, if there are four reception areas and each reception area respectively corresponds to parameters of the prize acquisition unit 6—namely, the movement amount of the prize acquisition unit 6, the movement speed of the prize acquisition unit 6, the opening degree of the two arms 61, and the power of the two arms 61—when same inputs are made to different reception areas, the movement amount of the prize acquisition unit 6, the movement speed of the prize acquisition unit 6, the opening degree of the two arms 61, and the power of the two arms 61 corresponding to each reception area are outputted.

The correlation between the plurality of reception areas in the example shown in FIG. 31 is configured such that the parameters corresponding to same inputs become smaller from one reception area located on one side in the first direction (the reception area corresponding to correspondence table 1 in FIG. 34) toward the other reception area located on the other side in the first direction (the reception area corresponding to correspondence table 3 in FIG. 34). With this configuration, the magnitude of the parameter for a given input can be intuitively manipulated according to the arrangement order.

Also, when the user touches the operation reception unit 900 with a finger or the like to perform a single sliding operation, the correlation relating to the start reception area to which the starting position of the touch operation belongs becomes the correlation applied to that one operation. Also, in the course of that single operation, even if the user's finger or the like should move to another reception area after starting, the correlation applied to that single operation is still the correlation relating to the starting reception area. With this configuration, the user can operate the prize acquisition unit while directly observing its movement, without looking at the operation reception unit 900.

### Detection Unit 1C

Next, the detection unit 1C will be described in detail with reference to FIGS. 1, 6, 8, and 9.

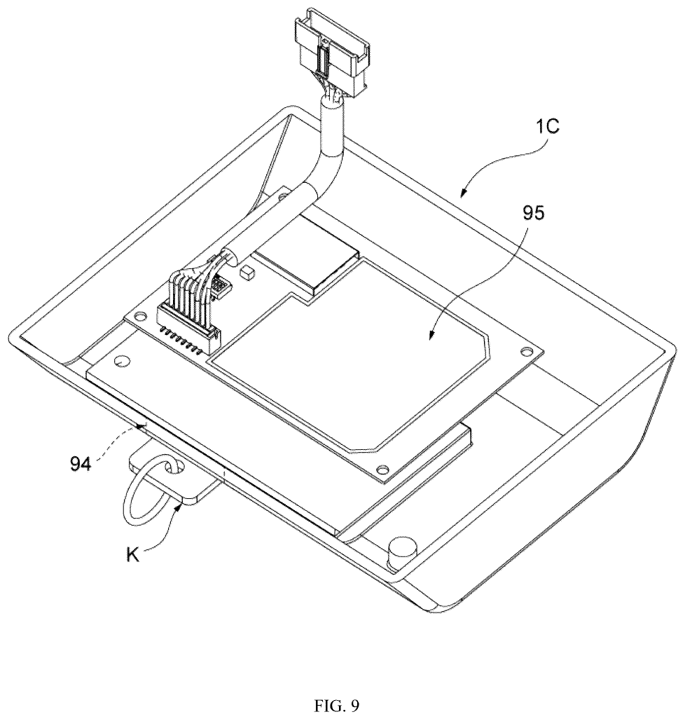

The detection unit 1C is an example of a configuration for detecting information stored on an information medium. The detection unit 1C is provided below the display panel 9C, and is a component shared by both the first prize catcher 1F and the second prize catcher 1G. As shown in FIG. 9, the detection unit 1C has one key insertion slot 94 for inserting an administrator key K, and one reading board 95 that identifies a first start request for activating an administration mode stored in the administrator key K. The detection unit 1C may be provided to each of the first prize catcher 1F and the second prize catcher 1G.

Here, the administrator key K is an example of an information medium. The reading board 95, together with a door sensor 98 of the service unit 1D (discussed below), constitutes an example of a detector that detects a request to start an administration mode used by an administrator. Also, the start request includes a first start request that the reading board 95 can detect when the administrator key K approaches the reading board 95, and a second start request that the door sensor 98 can detect when the service door 96 of the service unit 1D (discussed below) is opened. In other words, the reading board 95 is configured to detect a first start request stored in the administrator key K.

Also, the administrator key K may include an administrator key in which a plurality of different sets of start request information are stored. The first start request includes information such as the administrator ID and permissions. When an administrator key K is inserted into the key insertion port 94, the reading board 95 can read and detect whether the administrator key K is associated with the game device main body 1A, and it can read and detect the first start request stored in the administrator key K associated with the game device main body 1A. Also, the association between the administrator key K and the game device main body 1A can be set in the administration mode with an item called “Shared” (see FIG. 30) on the menu item screen displayed on the display operation panel 90. Also, the administrator key K can be registered as a group.

The administrator key K may also be a physical key instead of an information medium. In this case, the detection unit 1C detects a start request corresponding to a physical feature provided to a physical key (such as a recesses and protrusions on the blade portion of the physical key) in response to an operation by an administrator. More specifically, the detection unit 1C can, for example, detect the recesses and protrusions of the detected physical key, thereby reading and detecting whether the physical key is associated with the game device main body 1A, as well as reading and detecting the first start request corresponding to the recesses and protrusions of the physical key associated with the game device main body 1A.

### Service Unit 1D

Next, the service unit 1D will be described in detail with reference to FIG. 1.

The service unit 1D is an example of a configuration that allows an administrator perform settings related to the administration mode. As shown in FIG. 1, the service unit 1D has a service door 96 provided on the front of the game device main body 1A, a key unit 97 provided on the service door 96, a door sensor 98 for detecting the opening and closing of the service door 96, and a settings unit 99 provided inside the game device main body 1A.

The service door 96 is an example of a start operation device for starting the administration mode. The start operation device may be configured as an operation button, a key, or a detection device for detecting information stored on an information medium. The key unit 97 is configured for locking the service door 96. An administrator can unlock the service door 96 using a key corresponding to the key unit 97.

The door sensor 98, together with the reading board 95, constitutes an example of a detector that detects a request to start an administration mode used by an administrator. The door sensor 98 is configured to detect the opening and closing of the service door 96. More specifically, the door sensor 98 can detect a second start request among the start requests when the service door 96 is opened, and can detect the end of the setting processing via the settings unit 99 when the service door 96 is subsequently closed. The settings unit 99 is configured to perform shared settings for the first prize catcher 1F and the second prize catcher 1G.

### Control Unit 1E

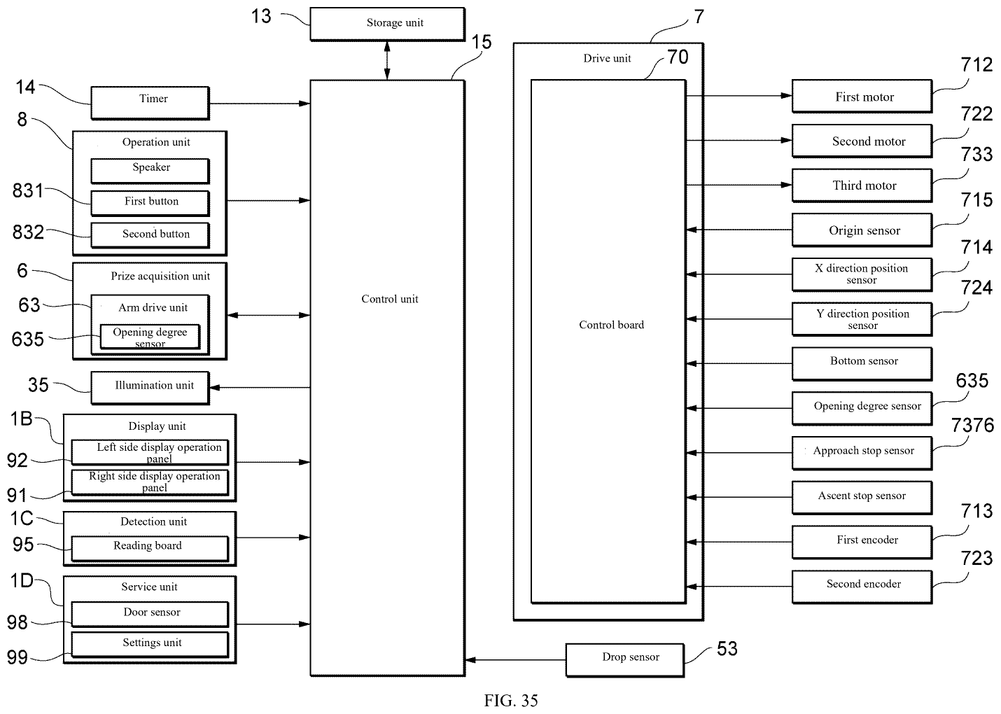

Next, the control unit 1E will be described in detail with reference to FIGS. 35 to 47.

The control unit 1E is an example of a configuration to control the overall operation of the prize acquisition game device 1. Also, the control unit 1E has a storage unit 13 that stores data and instructions such as programs used in a prize acquisition game, a timer 14 that acquires the current time, and a controller 15 for controlling various operations of the prize acquisition game device 1.

Upon receiving the user inputs accepted by the display unit 1, service unit 1D, and the operation part 83 of the game device main body 1A along with the time information acquired by the timer 14, the controller 15 executes a prize acquisition game by controlling the movement of the prize acquisition unit 6 in the game space S, the output of the speaker, the lighting of the prize display unit 3, and so forth based on the data and instructions stored in the storage unit 13.

### Details of Controller 15

Next, the controller 15 will be described in detail with reference to FIGS. 35 to 47.

### Functional Configuration of Controller 15

As shown in FIG. 35, the controller 15 is connected to the storage unit 13, timer 14, operation unit 8, display unit 1B, detection unit 1C, service unit 1D, prize acquisition unit 6, illumination unit 35, control board 70 of the drive unit 7, and drop detector 53. Also, the controller 15 is connected to the sensors of the prize acquisition unit 6 and the position sensors, motors, and encoders of the drive unit 7 via a connection to the control board 70. Thus, when it is detected that the user has inserted a specific play fee into the coin insertion slot 10, the controller 15 starts controlling a prize acquisition game in the game mode to cause it to execute the prize acquisition game. On the other hand, when the ID of the administrator key K has been identified, or when the service door 96 of the service unit 1D has been opened, the controller 15 starts controlling the administration mode so that settings of the prize acquisition game device 1 can be configured.

### Control Related to Administration Mode

The controller 15 controls the display in the first display area and/or the second display area based on the game progress status of the first prize acquisition game in the first prize catcher 1F and/or the second prize acquisition game in the second prize catcher 1G when the detection unit 1C detects a start request.

Also, when the detection unit 1C detects a first start request, the controller 15 can perform a first control that includes displaying an operation button for changing to a menu screen on the display operation panel 90 corresponding to the first prize catcher 1F and/or the second prize catcher 1G in which a game is in progress, and displaying a menu screen on the display operation panel 90 corresponding to the first prize catcher 1F and/or the second prize catcher 1G in which a game is not in progress.

Also, when the detection unit 1C detects a second start request, the controller 15 can perform a second control including displaying a menu screen on the first display operation panel 91 and the second display operation panel 92. Also, when the controller 15 simultaneously detects a first start request and a second start request, the controller 15 can perform a second control corresponding to the second start request.

Also, when an operation button is displayed on the first display operation panel 91 and an operation button or a menu screen is displayed on the second display operation panel 92, if the operation button displayed on the first display operation panel 91 is operated, the controller 15 can display a menu screen on the first display operation panel 91 and a game screen on the second display operation panel 92.

Also, when a menu screen is displayed on the first display operation panel 91 and an operation button or a menu screen is displayed on the second display operation panel 92, if one of the first menu items is selected on the menu screen displayed on the first display operation panel 91, the controller 15 can display the selected first menu item on the first display operation panel 91 and a game screen on the second display operation panel 92.

Also, the controller 15 can perform shared settings when the “dual screen operation” switch is turned on and a first menu item displayed on either the first display operation panel 91 or the second display operation panel 92 is operated.

### Control Related to Game Mode

Upon receiving a movement request inputted by the user via the first button 831 and the second button 832 of the operation unit 8 or the display operation panel 90 of the display 9, as well as time information acquired by the timer 14, the controller 15 drives the arm drive unit 63 of the prize acquisition unit 6 and the motors of the drive unit 7 based on the data and instructions stored in the storage unit 13, causing the main body part 60 of the prize acquisition unit 6 to move (planar movement and the Z direction movement) and the pair of arms 61 to open and close, thereby carrying out a prize acquisition game. Here, in the movement of the main body part 60, the controller 15 causes the main body part 60 to perform planar movement and then Z direction movement, for example. Also, the controller 15 executes output control of the illumination unit 35, the speaker, etc., in order to output lighting effects or sound effects according to the progress of the prize acquisition game, etc.

Also, the controller 15 can receive play information for each of the multiple plays on the prize acquisition unit 6 moved by the second method or movement information for the prize acquisition unit 6 moved by the first method, respectively transmitted from the position sensors of the drive unit 7, the drop detector 53, the opening degree sensor 635 of the arm drive unit 63, the reading board 95 of detection unit 1C and the timer 14, and store this information in the storage unit 13.

Here, the play information includes movement information and play history corresponding to each play. The movement information is information acquired by the position sensors and encoders of the drive unit 7 about past movements of the prize acquisition unit 6 that was moved by the first method and second method in the game space S. The play history includes the time at which each play was performed, which is acquired by the timer 14, whether a prize was acquired corresponding to each play, which was acquired by the drop detector 53, the number of consecutive plays to acquire one prize, the number of prizes obtained through continuous play, and so forth.

Also, the controller 15 can perform a first pressure adjustment to adjust the pressure applied to the prize or the prize support unit 40 by the arms 61, or a second pressure adjustment to adjust the pressure applied to the prize by the main body part 60, based on the contact state between the prize acquisition unit 6 and the prize or the prize support unit 40. The controller 15 performs the first pressure adjustment when the arms 61 of the prize acquisition unit 6 have moved beyond a specific threshold value. Also, the controller 15 performs the second pressure adjustment when the bottom part of the main body part 60 presses against the prize with a specific pressure. The first pressure adjustment is for reducing the pressure applied by the arms 61 to the prize or the prize support unit 40 by stopping the approach movement of the main body part 60. The second pressure adjustment is for reducing the pressure applied by the main body part 60 to the prize by stopping the approach movement of the main body part 60, then moving the main body part 60 a first distance in the retreat direction, and then stopping it.

Also, the controller 15 can determine the first distance so as to reduce the pressure applied by the main body part 60 to the prize to a specific value while maintaining contact between the bottom part 67 of the main body part 60 and the prize, depending on the type of prize.

### An Example of Control by Controller 15

Next, an example of control of the prize acquisition game by the controller 15 will be described in detail with reference to FIG. 1 and FIGS. 36 to 47. Depending on the settings, the controller 15 can control different prize acquisition games.

The controller 15 activates the game mode after the power is turned on to the prize acquisition game device 1. At this point, a “game screen” is displayed on the first display operation panel 91 and the second display operation panel 92. In game mode, an administrator can switch from game mode to administration mode by bringing the administrator key K close to the reading board 95 or by opening the service door 96. In administration mode, once the administrator finishes setting up the prize acquisition game device 1, the administration mode returns to game mode. Also, in both administration mode and game mode, main processing for performing prize acquisition can be executed. The administration mode setting processing performed by the controller 15 will now be described, followed by the main processing performed by the controller 15.

### Administration Mode Setting Processing by Controller 15

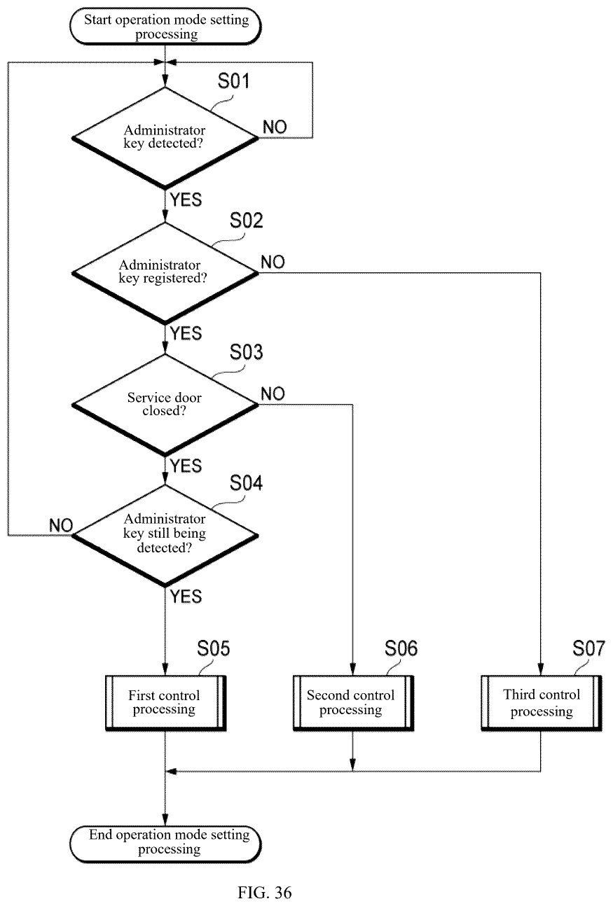

First, the administration mode setting processing performed by the controller 15 will be described with reference to FIGS. 36 to 41.

(Steps S01 to S04) First, the controller 15 detects the administrator key K (step S01). If it is determined that the administrator key has been detected (YES in step S01), the controller 15 determines whether the administrator key has been registered to the game device main body 1A used by the administrator key (step S02). If it is determined that the administrator key has been registered (YES in step S02), the controller 15 determines whether the service door 96 is closed (step S03). If it is determined that the service door 96 is closed (YES in step S03), the controller 15 then determines whether the administrator key K is still detected (step S04).

### (Step S05)

If it is determined that the administrator key is still detected (YES in step S04), the controller 15 performs a first control process (step S05).

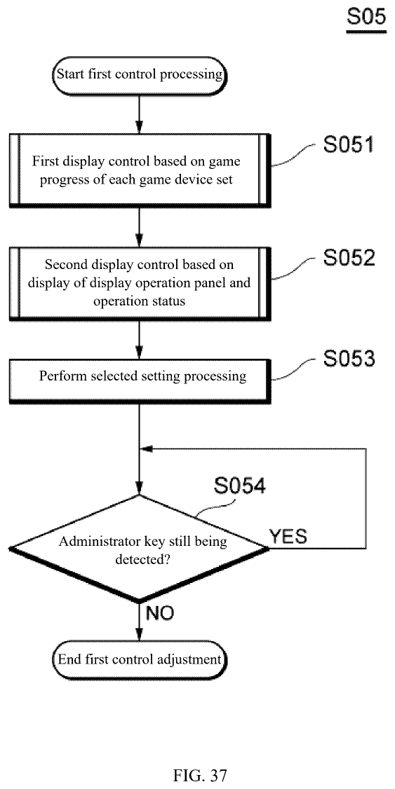

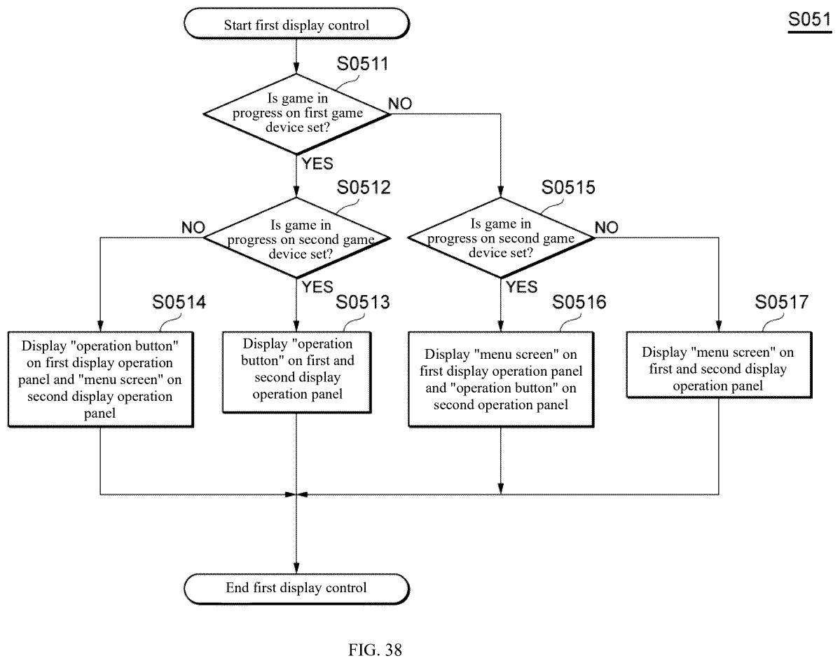

In step S05, the controller 15 performs the first display control based on the game progress status of each crane claw device, as shown in FIG. 37 (step S051). In step S051, as shown in FIG. 38, the controller 15 first determines whether a game is in progress on the first prize catcher 1F (step S0511). If it is determined that a game is in progress on the first prize catcher 1F (YES in step S0511), the controller 15 further determines whether a game is also in progress on the second prize catcher 1G (step S0512). If it is determined that a game is also in progress on the second prize catcher 1G (YES in step S0512), the controller 15 displays the “operation button” on the first display operation panel 91 and the second display operation panel 92 (step S0513), and then ends the first display control.

On the other hand, if it is determined that a game is not in progress on the second prize catcher 1G (NO in step S0512), the controller 15 displays the “operation button” on the first display operation panel 91 and displays the “menu screen” on the second display operation panel 92 (step S0514), and then ends the first display control.

Also, if it is determined that a game is not in progress on the first prize catcher 1F (NO in step S0511), the controller 15 determines whether a game is in progress on the second prize catcher 1G (step S0515). If it is determined that a game is in progress on the second prize catcher 1G (YES in step S0515), the controller 15 causes the “menu screen” to be displayed on the first display operation panel 91 and the “operation button” to be displayed on the second display operation panel 92 (step S0516), and then ends the first display control. On the other hand, if it is determined that a game is not in progress on the second prize catcher 1G (NO in step S0515), the controller 15 causes the “menu screen” to be displayed on both the first display operation panel 91 and the second display operation panel 92 (step S0517), and then ends the first display control.

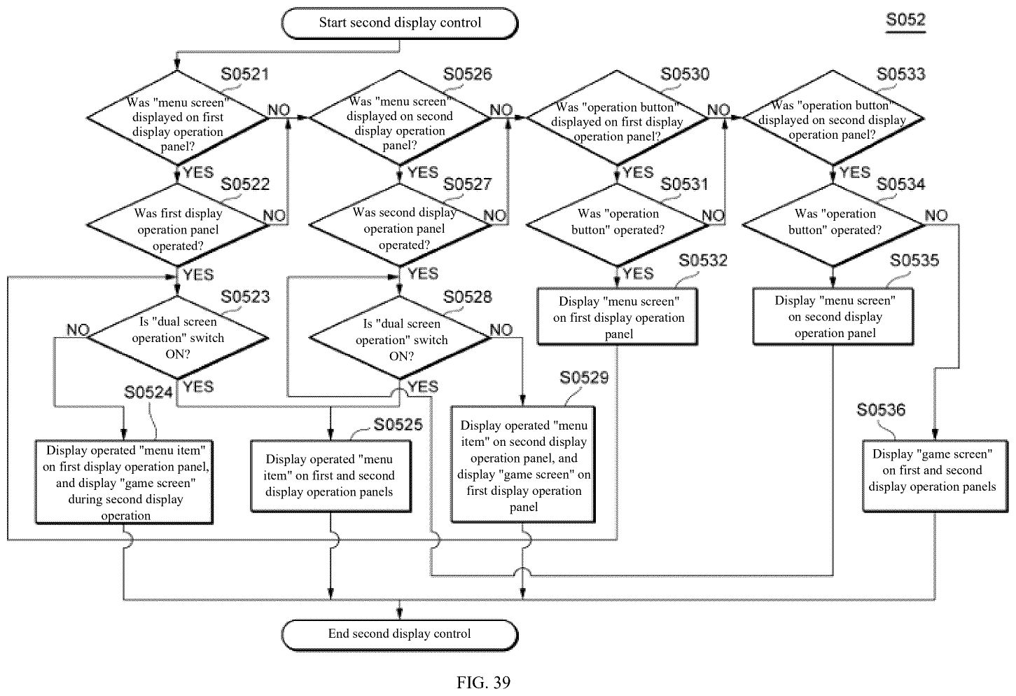

The description will now return to FIG. 37. After performing the first display control, the controller 15 performs the second display control based on the display of each operation panel 90 and the operation status of the administrator (step S052). In step S052, as shown in FIG. 39, the controller 15 first determines whether the “menu screen” is displayed on the first display panel 91 (step S0521). If it is determined that the “menu screen” is displayed on the first display operation panel 91 (YES in step S0521), the controller 15 determines whether the “menu screen” displayed on the first display operation panel 91 has been operated by the administrator (step S0522). If it is determined that the “menu screen” displayed on the first display operation panel 91 has been operated by the administrator (YES in step S0522), the controller 15 determines whether the “dual screen operation” switch on the “menu screen” has been turned on (step S0523). If it is determined that the “dual screen operation” switch on the “menu screen” has been turned off (NO in step S0523), the controller 15 displays the “menu item” selected in step S0522 on the first display operation panel 91, returns the display on the second display operation panel 92 to the “game screen” (step S0524), and ends the second display control.

Furthermore, the controller 15 displays the “menu item” selected in step S0522 on the first display operation panel 91 and the “game screen” on the second display operation panel 92, and then determines whether the operation on the “menu item” displayed on the first display operation panel 91 by the administrator has been completed and whether a game is currently in progress on the second prize catcher 1G corresponding to the second display operation panel 92. If it is determined that the operation on the first display operation panel 91 has been completed and that a game is not in progress on the second prize catcher 1G, the controller 15 can further display the game screen on the first display operation panel 91 and the menu screen on the second display operation panel 92.

On the other hand, if it is determined that the “dual screen operation” switch on the “menu screen” has been turned on (YES in step S0523), the controller 15 displays the “menu item” selected in step S0522 on both the first display operation panel 91 and the second display operation panel 92 (step S0525), and then ends the second display control.

Also, if it is determined that the “menu screen” is not displayed on the first display operation panel 91 (NO in step S0521), or if it is determined that the “menu screen” displayed on the first display operation panel 91 has not been operated by the administrator (NO in step S0522), the controller 15 then determines whether the “menu screen” is displayed on the second display operation panel 92 (step S0526). If it is determined that the “menu screen” is displayed on the second display operation panel 92 (YES in step S0526), the controller 15 then determines whether the “menu screen” displayed on the second display operation panel 92 has been operated by the administrator (step S0527). If it is determined that the “menu screen” displayed on the second display operation panel 92 has been operated by the administrator (YES in step S0527), the controller 15 then determines whether the “dual screen operation” switch on the “menu screen” has been turned on (step S0528). If it is determined the “dual screen operation” switch on the “menu screen” has been turned on (YES in step S0523), the controller 15 proceeds the processing to step S0525. On the other hand, if it is determined that the “dual screen operation” switch on the “menu screen” has been turned off (NO in step S0528), the controller 15 displays the “menu item” selected in step S0527 on the first display operation panel 91 and returns the display on the second display operation panel 92 to the “game screen” (step S0529), thereby ending the second display control.

If it is determined that the “menu screen” is not displayed on the second display operation panel 92 (NO in step S0526) or that the “menu screen” displayed on the second display operation panel 92 has not been operated by the administrator (NO in step S0527), the controller 15 determines whether the “operation button” is displayed on the first display operation panel 91 (step S0530). If it is determined that the “operation button” is displayed on the first display operation panel 91 (YES in step S0530), the controller 15 determines whether the “operation button” has been operated by the administrator (step S0531). If it is determined that the “operation button” has been operated by the administrator (YES in step S0531), the controller 15 displays the “menu screen” on the first display operation panel 91 (step S0532) and proceeds to step S0523.

If it is determined that the “operation button” is not displayed on the first display operation panel 91 (NO in step S0530) or that the “operation button” has not been operated by the administrator (NO in step S0531), the controller 15 determines whether the “operation button” is displayed on the second display operation panel 92 (step S0533). If it is determined that the “operation button” is displayed on the second display operation panel 92 (YES in step S0533), the controller 15 determines whether the “operation button” has been operated by the administrator (step S0534). If it is determined that the “operation button” has been operated by the administrator (YES in step S0534), the controller 15 displays the “menu screen” on the second display operation panel 92 (step S0535) and proceeds to step S0528. On the other hand, if it is determined that the “operation button” has not been operated by the administrator (NO in step S0534), the controller 15 returns the displays on the first display operation panel 91 and the second display operation panel 92 to the “game screen” (step S0536) and ends the second display control.

The description will now return to FIG. 37. After completing the second display control, the controller 15 performs the setting processing related to the menu item selected in steps S0524, S0525, and S0529 (see FIG. 39) (step S053). Then, the controller 15 determines whether the administrator key K is still being detected (step S054). If it is determined that the administrator key K is no longer being detected (NO in step S054), the controller 15 ends the first control process. On the other hand, if it is determined that the administrator key K is still being detected (YES in step S054), the controller 15 returns to the processing to step S054.

### (Step S06)

The description will now return to FIG. 36. If it is determined that the service door 96 is not closed NO in step S03), the controller 15 performs the second control process (step S06).

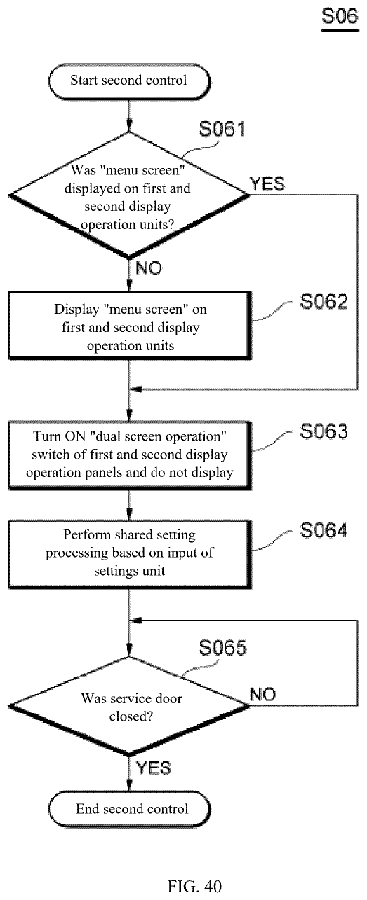

In the second control process, as shown in FIG. 40, the controller 15 first determines whether the “menu screen” is displayed on the first display operation panel 91 and the second display operation panel 92 (step S061). If it is determined that the “menu screen” is not displayed on the first display operation panel 91 and the second display operation panel 92 (NO in step S061), the controller 15 displays the “menu screen” on both the first display operation panel 91 and the second display operation panel 92 (step S062), turns on the “dual screen operation” switch on each “menu screen” of the first display operation panel 91 and the second display operation panel 92, and then hides the screen s (step S063). Then, the controller 15 performs the shared setting processing for the first prize catcher 1F and the second prize catcher 1G based on the information input by the administrator into the settings unit 99 (step S064). Then, the controller 15 determines whether the service door 96 has been closed (step S065). If it is determined that the service door 96 has been closed (YES in step S065), the controller 15 ends the second control.

On the other hand, if it is determined that the “menu screen” is displayed on the first display operation panel 91 and the second display operation panel 92 (YES in step S061), the controller 15 proceeds to step S063. Also, if it is determined that the service door 96 has not been closed (NO in step S065), the controller 15 returns the process to step S066.

### (Step S07)

The description will now return to FIG. 36. If it is determined that the administrator key K is not registered (NO in step S02), the controller 15 performs the third control process (step S07).

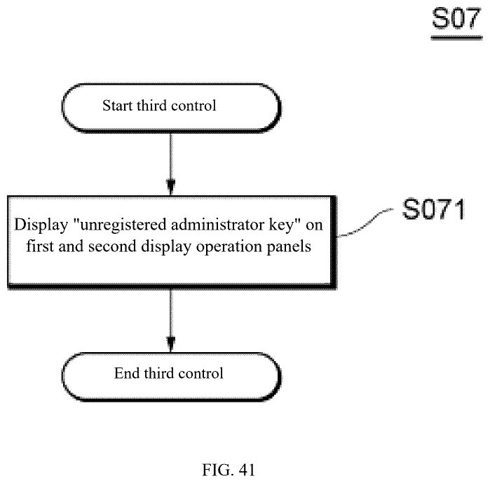

In step S07, as shown in FIG. 41, the controller 15 displays “unregistered administrator key” on the first display operation panel 91 and the second display operation panel 92 (step S071), and then ends the third control process.

The description will now return to FIG. 36. Subsequently, the controller 15 concludes the administration mode setting processing after ending one of the first control process, the second control process, or the third control process. After completing the administration mode setting processing, the controller 15 resumes the game mode and displays the “game screen” on the first display operation panel 91 and the second display operation panel 92.

If a second start request is detected while the first control process is being executed, the controller 15 can stop the ongoing first control process and perform the second control process corresponding to the second start request as an interrupt process. Additionally, if the controller 15 detects both the first start request and the second start request simultaneously, it can prioritize and execute the second control process corresponding to the second start request.

### Main Processing by Controller 15

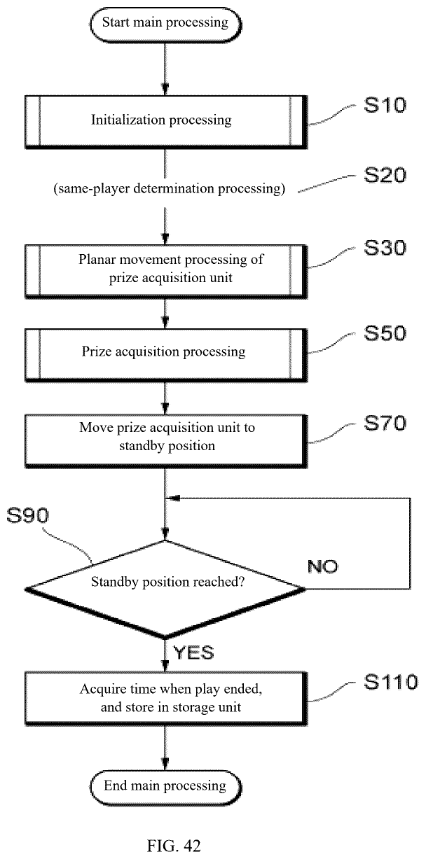

Next, the main processing performed by the controller 15 will be described with reference to FIGS. 42 to 47.

### (Step S10)

First, the controller 15 performs the initialization process (step S10).

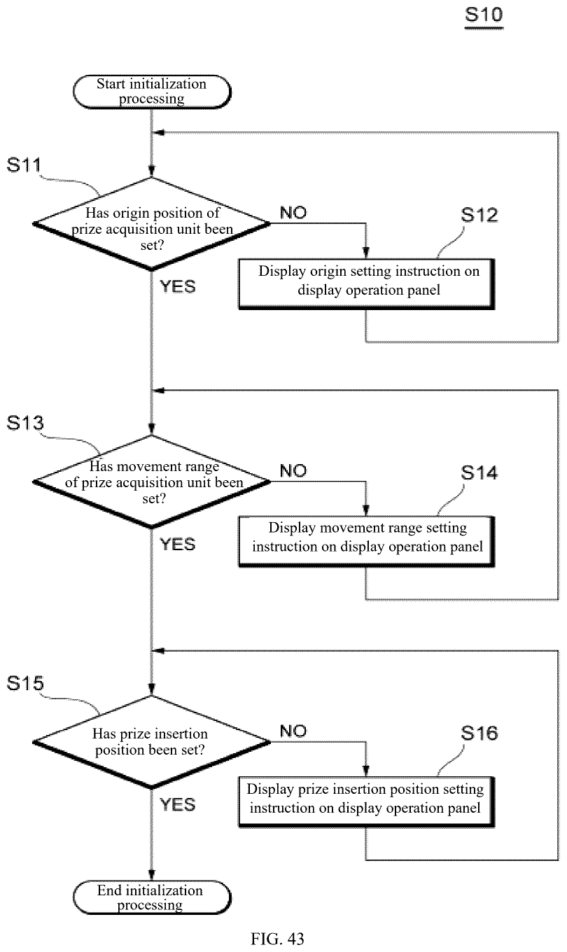

In step S10, as shown in FIG. 43, the controller 15 first determines whether the origin position of the prize acquisition unit 6 has been set (step S11). If it is determined that the origin position of the prize acquisition unit 6 has been set (YES in step S11), the controller 15 determines whether the movement range of the prize acquisition unit 6 has been set (step S13). If it is determined that the movement range of the prize acquisition unit 6 has been set (YES in step S13), the controller 15 determines whether the prize insertion position of the prize acquisition unit 6 has been set (step S15). If it is determined that the prize insertion position of the prize acquisition unit 6 has been set (YES in step S15), the controller 15 terminates the initialization process.

On the other hand, if it is determined that the origin position of the prize acquisition unit 6 has not been set (NO in step S11), the controller 15 displays an origin setting instruction on the display operation panel 90 (step S12). In this case, the administrator can manually move the prize acquisition unit 6 to the standby position using the first method based on the origin setting instruction. When the prize acquisition unit 6 stops at its standby position, the X direction origin sensor 715 and the Y direction origin sensor 725 of the drive unit 7 acquire the coordinates of the standby position of the prize acquisition unit 6 and send them to the controller 15. The controller 15 then sets the standby position as the origin and stores this information in the storage unit 13, and the processing moves on to step S13.

Similarly, if it is determined that the movement range of the prize acquisition unit 6 has not been set (NO in step S13), the controller 15 displays on the display operation panel 90 an instruction to set the movement range (step S14). In this case, the administrator can manually move the prize acquisition unit 6 along the desired movement range by the first method based on an instruction to set the movement range. Then, the X direction position sensor 714, the Y direction position sensor 724, the first encoder 713, and the second encoder 723 of the drive unit 7 acquire the coordinates of points on the movement path and transmit these to the controller 15. The controller 15 then stores the movement range information in the storage unit 13, and the processing moves on to step S15.

Also, if it is determined that the prize insertion position of the prize acquisition unit 6 has not been set (NO in step S15), the controller 15 displays on the display operation panel 90 an instruction to set the prize insertion position (step S104). In this case, the administrator can manually move the prize acquisition unit 6 to the desired prize insertion position by the first method based on the instruction to set the prize insertion position. Then, the X direction position sensor 714, the Y direction position sensor 724, the first encoder 713, and the second encoder 723 of the drive unit 7 acquire the coordinates of points on the movement path and transmit these to the controller 15. Then, the controller 15 stores the prize insertion position information in the storage unit 13, and then terminates the initialization process.

### (Step S20)

The description will now return to FIG. 42. When the game mode is selected in the usage mode setting processing, the controller 15 performs same-player determination processing (step S20).

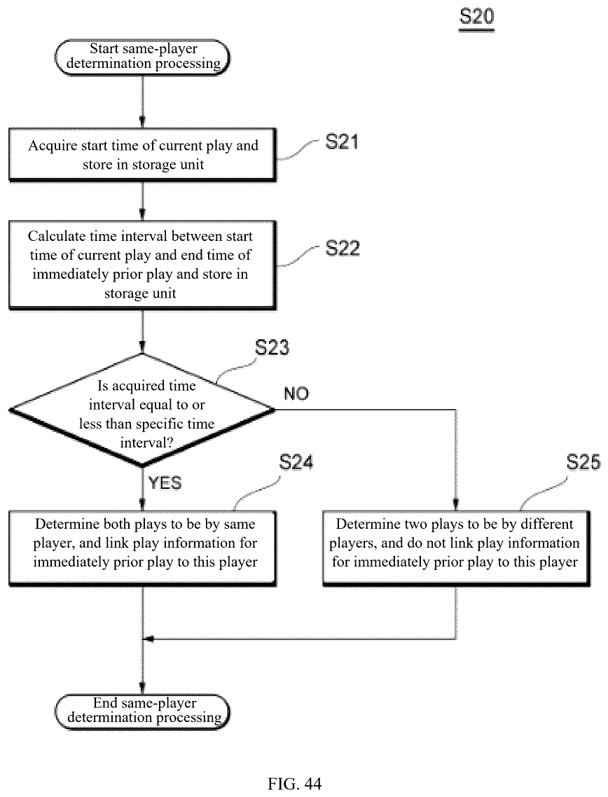

In step S20, as shown in FIG. 44, the controller 15 first acquires play information related to the start time of the current play and stores it in the storage unit 13 (step S21), and then calculates play information related to the time interval between the start time of the current play and the end time of the immediately prior play stored in the storage unit 13, and stores this in the storage unit 13 (step S22). Next, the controller 15 determines whether the acquired time interval is less than or equal to a specific time interval (such as 60 seconds) (step S23). If it is determined that the time interval is less than or equal to the specific time interval (YES in step S23), the controller 15 determines that both plays were done by the same player, and it links the play information for the immediately prior play or the play information linked to the play information for the immediately prior play to this player (step S24), and ends the same-player determination processing.

On the other hand, if it is determined that the specific time interval has been exceeded (NO in step S23), the controller 15 determines that the two plays were not done by the same player, and ends the same-player determination processing without linking to the same player the play information for the immediately prior play or the play information linked to the play information for the immediately prior play (step S25).

In addition, in the same-player determination processing, the controller 15 may notify the administrator that the count for measuring the time interval from the end time of play to the start time of the next play, which is set with the multipurpose switch, has been paused. In this case, based on the above-mentioned notification, the administrator can operate the multipurpose switch to pause the counting of the time interval, and then resume the count after any trouble has been resolved. When the counting of the time interval is paused in this manner, if a player attempts to play continuously but is unable to play due to a technical trouble with the prize acquisition game device 1, the controller 15 can determine that the player after the counting of the time interval is resumed is the same player as the player before the counting of the time interval was paused. As a result, it is possible to prevent the player from having to stop playing continuously due to a technical trouble, and the player can proceed through the prize acquisition game as desired, thereby improving the satisfaction of the player with the prize acquisition game.

### (Step S30)

The description will now return to FIG. 42. Next, the controller 15 performs planar movement processing for the prize acquisition unit 6 (step S30).

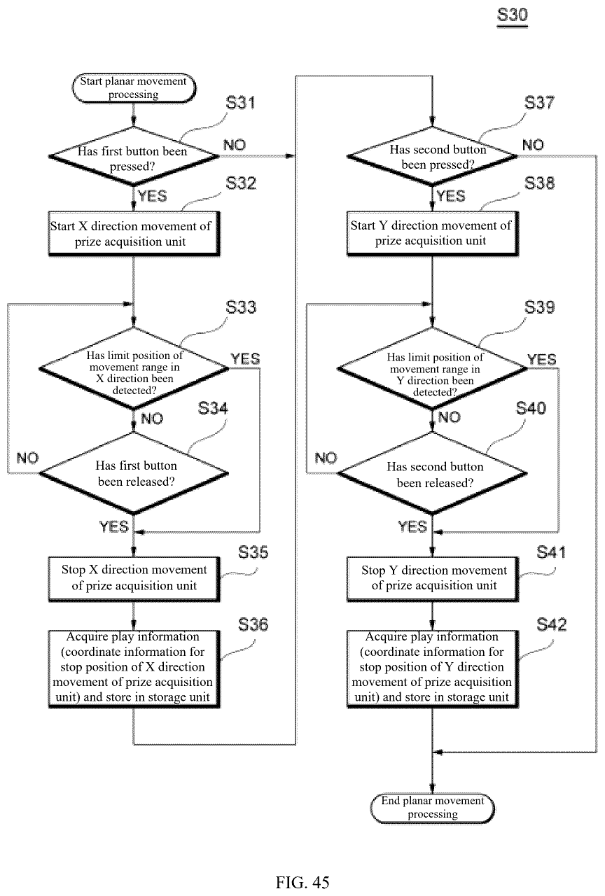

In step S30, the controller 15 first moves the prize acquisition unit 6 in the X direction, as shown in FIG. 45. More specifically, the controller 15 determines whether the first button 831 has been pressed by the player (step S31). If it is determined that the first button 831 has been pressed by the player (YES in step S31), the controller 15 actuates the first motor 712 based on the operation signal from the first button 831 to start moving the prize acquisition unit 6, which was located at the standby position (origin), in the X direction (step S32). Next, the controller 15 determines whether the prize acquisition unit 6 has moved to the limit position of its movement range in the X direction based on a movement limit detection signal from the X direction dog 716 (step S33). If it is determined that the prize acquisition unit 6 has not moved to the limit position of its movement range in the X direction (NO in step S33), the controller 15 determines whether the player has released the first button 831 (step S34). If it is determined that the player has released the first button 831 (YES in step S34), the controller 15 stops the movement of the prize acquisition unit 6 in the X direction (step S35). After step S35 is performed, the prize acquisition unit 6 is located at the stop position of its movement in the X direction, that is, at the direction change point. The controller 15 then acquires the play information sent by the position sensors and encoders of the drive unit 7, that is, the coordinate information for the direction change point, and stores this in the storage unit 13 (step S36).

After this, the controller 15 causes the prize acquisition unit 6 to move in the Y direction. More specifically, the controller 15 determines whether the second button 832 has been pressed by the player (step S37). If it is determined that the second button 832 has been pressed by the player (YES in step S37), the controller 15 actuates the second motor 722 based on the operation signal from the second button 832 to start moving the prize acquisition unit 6, which is located at the direction change point, in the Y direction (step S38). Next, the controller 15 determines whether the prize acquisition unit 6 has moved to the limit position of its movement range in the Y direction based on the movement limit detection signal from the Y direction dog 726 (step S39). If it is determined that the prize acquisition unit 6 has not moved to the limit position of its movement range in the Y direction (NO in step S39), the controller 15 determines whether the player has released the second button 832 (step S40). If it is determined that the player has released the second button 832 (YES in step S40), the controller 15 stops the movement of the prize acquisition unit 6 in the Y direction (step S41). After step S41 is performed, the prize acquisition unit 6 is located at the stop position of its movement in the Y direction, that is, at the approach starting point. The controller 15 then acquires the play information sent by the position sensors and encoders of the drive unit 7, that is, the coordinate information for the approach starting point, stores this in the storage unit 13 (step S42), and ends the planar movement processing.

On the other hand, in the above planar movement processing, if it is determined that the first button 831 has not been pressed by the player (NO in step S31), the controller 15 moves the processing to step S37. If it is determined that the prize acquisition unit 6 has moved to the limit position of its movement range in the X direction (YES in step S33), the controller 15 moves the processing to step S35. If it is determined that the player has not released the first button 831 (NO in step S34), the controller 15 returns the processing to step S33. If it is determined that the second button 832 has not been pressed by the player (NO in step S37), the controller 15 ends the planar movement processing. If it is determined that the prize acquisition unit 6 has moved to the limit position of its movement range in the Y direction (YES in step S39), the controller 15 moves the processing to step S41. If it is determined that the player has not released the second button 832 (NO in step S40), the controller 15 returns the processing to step S39.

### (Step S50)

The description will now return to FIG. 42. Once the planar movement processing for the prize acquisition unit 6 is ended, the controller 15 performs prize acquisition processing for the prize acquisition unit 6 (step S50).

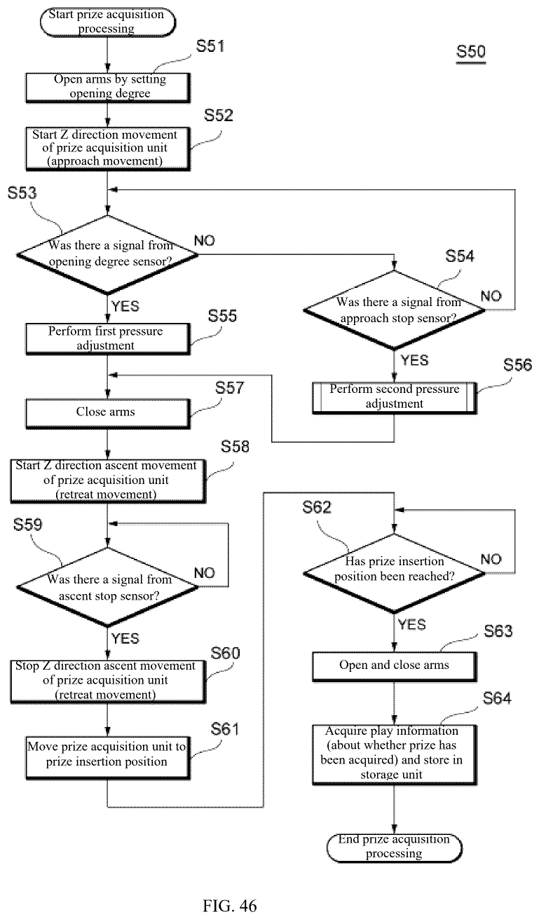

In step S50, as shown in FIG. 46, the controller 15 first adjusts the approach movement of the prize acquisition unit 6, the opening and closing of the arms 61, and the pressure. More specifically, the controller 15 actuates the arm drive unit of the prize acquisition unit 6 to open the pair of arms 61 of the prize acquisition unit 6 at the approach starting point by a set degree of opening (step S51). Then, the controller 15 actuates the third motor 733 to start the Z direction descent direction movement of the prize acquisition unit 6, that is, approach movement (step S52). Next, the controller 15 determines whether there is a detection signal from the opening degree sensor 635 indicating that the arms 61 have moved beyond a specific threshold value due to contact with a prize or the prize support unit 40 (step S53). If it is determined that there is a detection signal from the opening degree sensor 635 (YES in step S53), the controller 15 performs a first pressure adjustment to reduce the pressure applied by the arms 61 to the prize or the prize support unit 40 (step S55). In step S55, the controller 15 stops the approach movement of the prize acquisition unit 6. The controller 15 then actuates the arm drive unit of the prize acquisition unit 6 to close the pair of arms 61, thereby causing the prize to be grasped (step S57).

The controller 15 then causes the prize acquisition unit 6 to move to the prize insertion position. More specifically, after closing the pair of arms 61, the controller 15 actuates the third motor 733 to start the Z direction ascent direction of the prize acquisition unit 6, that is, retreat movement (step S58). Next, the controller 15 determines whether the prize acquisition unit 6 has moved to the limit position of its movement range in the Z direction based on whether there is a request to stop the ascent movement from the ascent stop sensor (step S59). If it is determined that there is a request from the ascent stop sensor to stop the ascent movement (YES in step S59), the controller 15 stops the Z direction ascent direction movement of the prize acquisition unit 6 (retreat movement) (step S60). Next, the controller 15 actuates the second motor 722 and then the first motor 712 to move the prize acquisition unit 6 toward the prize insertion position (step S61). In step S61, the controller 15 causes the prize acquisition unit 6 to move in the Y direction and the X direction. The controller 15 then determines whether the prize acquisition unit 6 has reached the prize insertion position (step S62). If it is determined that the prize acquisition unit 6 has reached the prize insertion position (YES in step S62), the controller 15 actuates the arm drive unit of the prize acquisition unit 6 to open and then close the pair of arms 61 (step S63).

Here, if the pair of arms 61 have grasped the prize in step S57, the pair of arms 61 are opened in step S63 to drop the prize through the first drop opening 51. When the prize drops, the prize passes through the second drop opening 52 and is temporarily accommodated in the prize accommodating unit 11. Also, the prize is detected by the drop detector 53 upon passing through the second drop opening 52. Consequently, it can be detected whether a prize is acquired in each play. The controller 15 then acquires play information, which is sent by the drop detector 53, related to information about whether a prize has been acquired, stores this in the storage unit 13 (step S64), and ends the prize acquisition processing. At this point the controller 15 ends the main processing.

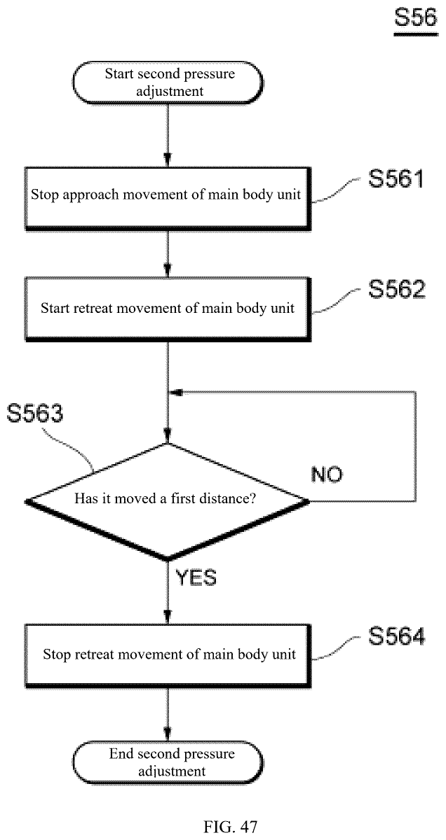

On the other hand, if it is determined that there is no detection signal from the opening degree sensor 635 (NO in step S53), the controller 15 determines whether there is a detection signal from the approach stop sensor 7376 that indicates that the bottom part 67 of the main body part 60 has come into contact with the prize and is pressing against the prize with a specific pressure (step S54). If it is determined that there is a detection signal from the approach stop sensor 7376 (YES in step S54), the controller 15 performs a second pressure adjustment to reduce the pressure applied to the prize by the main body part 60 (step S56). In step S56, as shown in FIG. 47, the controller 15 stops the approach movement of the main body part 60 (step S561), and then starts the retreat movement of the main body part 60 (step S562). Next, the controller 15 determines whether the main body part 60 has moved a first distance in the retreat direction (step S563). In step S563, the controller 15 determines the first distance so as to reduce the pressure applied by the main body part 60 to the prize to a specific value while maintaining contact between the bottom part 67 of the main body part 60 and the prize, depending on the type of prize. If it is determined that the main body part 60 has moved the first distance in the retreat direction (YES in step S563), the controller 15 stops the retreat movement of the main body part 60 (step S564) and ends the second pressure adjustment. On the other hand, if it is determined that the main body part 60 has not moved the first distance in the retreat direction (NO in step S563), the controller 15 returns the processing to step S563.

If it is determined that the prize acquisition unit 6 has not moved to the limit position of its movement range in the Z direction (NO in step S59), the controller 15 returns the processing to step S59. If it is determined that the prize acquisition unit 6 has not reached the prize insertion position (NO in step S62), the controller 15 returns the processing to step S62.

### (Steps S70, 90, and 110)

The description will now return to FIG. 42. Once the prize acquisition processing of the prize acquisition unit 6 is ended, the controller 15 moves the prize acquisition unit 6 to the standby position (step S70). After this, the controller 15 determines whether the prize acquisition unit 6 has arrived at the standby position (step S90). If it is determined that the prize acquisition unit 6 has arrived at the standby position (YES in step S90), the controller 15 acquires the end time of the play, stores this in the storage unit 13 (step S110), and ends the main processing. On the other hand, if it is determined that the prize acquisition unit 6 has not arrived at the standby position (NO in step S90), the controller 15 returns the processing to step S90.

The prize acquisition game device 1 according to the embodiments described above comprises a game device main body 1A having a first prize catcher 1F with which a first player can play a first prize acquisition game, and a second prize catcher 1G that is disposed alongside the first prize catcher 1F and with which a second player can play a second prize acquisition game; a display unit 1B, which is an example of a display that is disposed on the front side of the game device main body 1A and that has a first display operation panel 91, which is an example of a first display area used for the first prize catcher 1F, and a second display operation panel 92, which is an example of a second display area used for the second prize catcher 1G; a detection unit 1C, which is an example of a detector that detects a request to start an administration mode used by an administrator; and a control unit 1E, which is an example of a control unit that controls the display by the first display operation panel 91 and/or the second display operation panel 92 based on the game progress status of the first prize acquisition game and/or the second prize acquisition game when the detection unit 1C detects a start request. As a result, when the administrator switches to administration mode, it becomes possible to display different information based on the progress status of the prize acquisition game, which increases the satisfaction of both the administrator and the player.

Also, in the prize acquisition game device 1 according to the embodiments described above, the start request includes a first start request that the detection unit 1C can detect from the approach of an administrator key K, which is an example of an information medium associated with the game device main body 1A, and when the detection unit 1C detects a first start request, the control unit 1E performs a first control that includes determining whether a game is in progress on the first prize catcher 1F and the second prize catcher 1G, and displaying a menu screen on the display operation panel 90 corresponding to the crane claw device in which a game is not in progress. As a result, the administrator can switch to the administration mode even while a player's prize acquisition game is in progress without the unintended interruption of the prize acquisition game being played by the player. In should be noted that the administrator key K may be a physical key, in which case the first start request may be detected from the operation of the administrator key K by the administrator.

Also, the prize acquisition game device 1 according to the embodiments described above further comprises a service door 96, which is an example of a start operation device that starts the administration mode, the start request includes a second start request that the detection unit 1C can detect from the opening of the service door 96, and when the detection unit 1C detects a second start request, the control unit 1E performs a second control to display a menu screen on the first display operation panel 91 and the second display operation panel 92. As a result, the displays in the first display area and the second display area can be simultaneously switched to the menu screen by a simple method.

Also, in the prize acquisition game device 1 according to the embodiments described above, when the detection unit 1C simultaneously detects a first start request and a second start request that can be detected from the approach of the administrator key K associated with the game device main body 1A, the control unit 1E performs a second control corresponding to a second start request. As a result, the second control corresponding to the second start request can be performed preferentially when the first start request and the second start request are detected simultaneously.

Also, in the prize acquisition game device 1 according to the embodiments described above, the first control further includes displaying an operation button, which is an example of an operation object for changing to a menu screen in the display area corresponding to a crane claw device in which a game is in progress, and when an operation button is displayed on the first display operation panel 91, which is an example of a first display area, and the operation button displayed on the first display operation panel 91 is operated, the control unit 1E displays a menu screen on the first display operation panel 91 and a game screen on the second display operation panel 92. As a result, when one of the display operation panels is operated, the other display operation panel is returned to the game screen, and a prize acquisition game can be played on the crane claw device corresponding to the other display operation panel.

Also, in the prize acquisition game device 1 according to the embodiments described above, when a menu screen is displayed on the first display operation panel 91, which is an example of a first display area, and one of the menu items on the menu screen displayed on the first display operation panel 91 is selected, the control unit 1E displays the selected menu item on the first display operation panel 91 and also displays a game screen on the second display operation panel 92. As a result, when one of the display operation panels is operated, the other display operation panel is returned to the game screen, and a prize acquisition game can be played on the crane claw device corresponding to the other display operation panel.

Also, in the prize acquisition game device 1 according to the embodiments described above, the control unit 1E displays the selected menu item on the first display operation panel 91 and displays a game screen on the second display operation panel 92, and then determines whether the administrator has finished operating the menu item displayed on the first display operation panel 91 and whether a game is in progress on the second prize catcher 1G corresponding to the second display operation panel 92, and if it is determined that the operation on the first display operation panel 91 has finished and a game is not in progress on the second prize catcher 1G, a game screen is displayed on the first display operation panel 91 and a menu screen is displayed on the second display operation panel 92. As a result, the administrator can easily carry out successive operations on the second prize catcher.

Also, in the prize acquisition game device 1 according to the embodiments described above, the menu screen includes a “dual screen operation” switch, which is an example of a linked settings object for simultaneously performing shared settings for the first prize catcher 1F and the second prize catcher 1G, and a first menu item, which is an example of a menu item, and the control unit 1E makes the shared settings when the “dual screen operation” switch is turned on and the first menu item displayed on either the first display operation panel 91 or the second display operation panel 92 is operated. As a result, shared settings for the first prize catcher and the second prize catcher can be performed with a simple method.

The present invention is not limited to or by the embodiments described above, and suitable design changes made to the above embodiments by a person skilled in the art are also encompassed by the scope of the present invention as long as they still have the features of the present invention. That is, the elements of the embodiments described above, as well as their arrangement, material, condition, shape, size, and the like, are not limited to the examples and may be changed as needed. Also, the elements of the embodiments described above can be combined to an extent that this is technically possible, and these combinations are also encompassed by the scope of the present invention as long as they still have the features of the present invention.

### REFERENCE SIGNS LIST

1 . . . prize acquisition game device
1A . . . game device main body
1B . . . display unit
1C . . . detection unit
1D . . . service unit
1E . . . control unit
1F . . . first prize catcher
1G . . . second prize catcher
6 . . . prize acquisition unit
9 . . . display
9A . . . first display
9B . . . second display
15 . . . controller
91 . . . first display operation panel
92 . . . second display operation panel

What is claimed is:

1. A prize acquisition game device, comprising:
a game device main body that comprises:
a first prize catcher that comprises a first arm extending in a vertical direction of the prize acquisition game device and with which a first player plays a first prize acquisition game, and
a second prize catcher that is disposed alongside the first prize catcher, comprises a second arm extending in the vertical direction, and with which a second player plays a second prize acquisition game;
a display device that is disposed on a front side of the game device main body and has a first display for the first prize catcher and a second display for the second prize catcher;
a detector that detects a start request to start an administration mode used by an administrator; and
a controller that controls at least one of the first display and the second display based on at least one of a game progress status of the first prize acquisition game and a game progress status of the second prize acquisition game in response to the detector detecting the start request.

2. The prize acquisition game device according to claim 1, wherein
the start request includes a first start request that the detector can detect from an approach of an information medium associated with the game device main body or an operation of a physical key, and
in response to the detector detecting the first start request,
the controller performs a first control that includes:
determining whether the first prize acquisition game is in progress in the first prize catcher and whether the second prize acquisition game is in progress in the second prize catcher, and
displaying a menu screen in at least one of the first display and the second display corresponding to at least one of the first prize catcherin which the first prize acquisition game is not in progress and the second prize catcher in which the second prize acquisition game is not in progress.

3. The prize acquisition game device according to claim 1, further comprising:
a start operation device that starts the administration mode,
the start request includes a second start request that the detector can detect from an operation of the start operation device, and
in response to the detector detecting the second start request,
the controller performs a second control to display the menu screen in each of the first display and the second display.

4. The prize acquisition game device according to claim 3, wherein
the controller performs the second control corresponding to the second start request in response to the detector simultaneously detecting a first start request that the detector can detect from an approach of an information medium associated with the game device main body or an operation of a physical key and the second start request.

5. The prize acquisition game device according to claim 3, wherein
the first control further includes displaying an operation object for shifting to the menu screen in at least one of the first display corresponding to the first prize catcher in which the first prize acquisition game is in progress and the second display corresponding to the second prize catcher in which the second prize acquisition game is in progress, and
in response to the operation object displayed in the first display being operated while the operation object is being displayed in the first display, the controller displays the menu screen in the first display and displays a game screen in the second display.

6. The prize acquisition game device according to claim 3, wherein
while the menu screen is being displayed in the first display, in response to one of menu items on the menu screen displayed in the first display being selected, the controller displays the selected menu item in the first display and the game screen in the second display.

7. The prize acquisition game device according to claim 6, wherein
after displaying the selected menu item in the first display and displaying the game screen in the second display, the controller determines whether an operation of the menu item displayed in the first display has finished and whether the second prize acquisition game is in progress in the second prize catcher corresponding to the second display, and
upon determining that the operation in the first display has finished and that the second prize acquisition game is not in progress in the second prize catcher, the controller displays the game screen in the first display and displays the menu screen in the second display.

8. The prize acquisition game device according to claim 2, wherein
the menu screen includes a menu item along with a linked settings object for simultaneously performing shared settings for the first prize catcher and the second prize catcher, and
the controller performs the shared settings in response to the linked settings object being turned on and the menu item displayed in either the first display or the second display being operated.
